(19) United States
(12) Patent Application Publication
(10) Pub. No.: US 2025/0318525 A1
(43) Pub. Date: Oct. 16, 2025

(54) COMPOSITIONS TO CONTROL THE RELEASE RATES OF CHEMICAL PESTICIDES

(71) Applicant: Nicholas J Robertson, Ashland, WI (US)

(72) Inventor: Nicholas J Robertson, Ashland, WI (US)

(21) Appl. No.: 18/637,243

(22) Filed: Apr. 16, 2024

Related U.S. Application Data
(63) Continuation of application No. 16/942,422, filed on Jul. 29, 2020.

(51) Int. Cl. A01N 37/38; A01N 25/08; A01N 25/10; A01N 43/08; A01N 43/40; A01P 3/00; A01P 13/00

(52) U.S. Cl. CPC A01N 37/38; A01N 25/08; A01N 25/10; A01N 43/08; A01N 43/40; A01P 3/00; A01P 13/00

(57) ABSTRACT

A pesticide combined with a metal having a valency of +2 or higher used in a process for controlling a release rate of a carboxyl-containing pesticide by selecting the metal in the composition such that the rate of release can be adjusted by the metal selected.

### CROSS-REFERENCE TO RELATED APPLICATIONS

This application claims the benefit of U.S. Non Provisional Application No. 16/942,422, filed Jul. 29, 2020, U.S. Provisional Application No. 62/879,812 filed Jul. 29, 2019 and U.S. Provisional Application No. 62/905,040, filed Sep. 24, 2019.

### FIELD OF THE INVENTION

This invention discloses new pesticide formulations and a process for making them with adjustable release rates. The technology is applicable to pesticides containing one or more carboxyl groups where pairing with an appropriate metal-containing ingredient enables the desired release rate into the targeted system.

### BACKGROUND OF THE INVENTION

Active ingredients, such as pesticides, nutrients and dyes, often exhibit better efficacy when desired concentrations are maintained for longer time periods.

Pesticides are substances that are meant to control pests, including weeds. A pest is any animal or plant unwanted and/or detrimental to humans or human concerns. The term pesticide includes all of the following: herbicide, insecticides (which may include insect growth regulators, termiticides, etc.) nematicide, molluscicide, piscicide, avicide, rodenticide, bactericide, insect repellent, animal repellent, antimicrobial, and fungicide.

In general, a pesticide is a chemical or biological agent that deters, incapacitates, kills, or otherwise discourages pests. Target pests can include insects, plant pathogens, weeds, invasive species, molluscs, birds, mammals, fish, nematodes (roundworms), and microbes that destroy property, cause nuisance, or spread disease, or are disease vectors.

In terrestrial applications, pesticides can be carried away through rain events or volatilization. As climate change is leading to more frequent heavy rains and flooding, technologies capable of preventing active ingredients from being washed off site during these events are desirable. In agricultural uses, volatilization can be particularly detrimental as offsite drift can harm crops in neighboring fields. This has been a significant problem for dicamba herbicide, as hundreds of millions of dollars of crop damage have occurred through this mechanism. Essential nutrient depletion is also a terrestrial challenge as metals needed for plant growth can become locked in soil structures or washed below the root level. The technology disclosed herein can address these three issues by pairing an active ingredient with a metal ion. Pairing an active ingredient with a metal ion reduces the vapor pressure to near zero to prevent off site drift, can prevent washing away, and lastly, the metal ion can be chosen to replenish low level essential nutrients in the soil.

Many pesticides that contain carboxylic acids are used in the amine-salt form, in which an amine, such as dimethyl amine or isopropyl amine, deprotonates the carboxylic acid to form an ammonium carboxylate ion pair. This combination can increase water solubility and reduce vapor pressure. However, it is a reversible reaction, so when it is exposed to water, the ammonium-carboxylate ion pair can reverse to form the carboxylic acid and free amine. Once back in carboxylic acid form, the vapor pressure of the molecule increases and has a higher propensity to drift off site through volatilization. If the molecule remains as the ion pair, its increased solubility can lead to it dissolving in rain events, and being carried away from the target laterally or vertically through the soil column. Pairing these types of pesticides with a metal ion instead of an ammonium ion provides the ability to balance the metal ion pair attributes of reduced volatility and time release by optimizing the solubility of the ion pair through judicious choice of the associated metal ion.

When used in aquatic applications, currents can rapidly carry an active ingredient away from the target site, which reduces efficacy and can lead to undesirable non-target effects. Technologies to keep active ingredients in the target area for longer durations can help mitigate off site drift to reduce negative environmental impacts and improve efficacy.

Unwanted species in an aquatic system are a challenging problem to manage because the target is often submerged and more difficult to access than terrestrial nuisance species. Approaches to manage nuisance aquatic species include biological control, physical removal or chemical treatment. Many different chemicals are available for aquatic uses as pesticides, nutrients or dyes. These chemicals are used to impart an effect on a target organism, with the goal of pesticides being to destroy or repel the unwanted species.

A significant challenge impacting the use of pesticides in an aquatic system is maintaining the desired concentration for the prescribed time needed to ensure an effective treatment. Target concentrations are often prematurely reduced through water exchange processes such as dilution or off site drift due to currents. Shortened pesticide contact times with the target species frequently leads to ineffective treatments. This necessitates follow up treatments which carries additional cost and negative environmental impacts. New methods and formulations that offer sustained release rates are needed to better treat target species, especially for spot treatments or in locations where there is significant water turnover. Furthermore, the ability to meet these needs carries substantial environmental advantages because spot treatments can eradicate a nuisance species before they have a chance spread to larger areas and subsequently require significantly more chemical treatment to control.

Many contact and systemic aquatic pesticides with different modes of action have been developed for the treatment of a variety of unwanted aquatic species. Each of these pesticides have unique concentration exposure time (CET) relationships to achieve the desired results, which can also be dependent upon the target species. Some pesticides have ideal exposure times that range from hours to days while others range from days to weeks. Current methods used to control release rates commonly rely upon solubility of the active ingredient, carrier particle solubility, ion exchange, applying a specialty coating or combinations thereof. Formulations that offer a means for more precisely modifying release rates of active ingredients into aquatic environments would better enable CET optimization leading to more effective pesticide treatments. Our process meets these needs in unexpected ways.

The present disclosure demonstrates how one or more active ingredients, such as pesticides, containing one or more carboxylic acids or carboxylates can be partnered with an appropriate metal-containing ingredient to lead to solubilization by controlling the reaction rate or by directly altering the solubility of the active ingredient. This simple method enables the user to independently tune release rates of the active ingredients, which has not previously been available.

### SUMMARY OF THE INVENTION

Controlling release rates of chemicals into environments with constant or frequent water exposure is important for a variety of applications. The user of this method selects a molecular pairing in which an attractive interaction between the pair enables the user to controllably increase or decrease the solubility and subsequent release rate of the molecule or atom of interest. The attractive interaction can be an ion pair or a Lewis acid-base pairing. In a preferred embodiment, the molecule of interest contains one or more carboxyl groups and it is paired with a metal containing species. In another preferred embodiment the molecule of interest is a pesticide containing one or more carboxyl groups.

### BRIEF DESCRIPTION OF DRAWINGS

FIG. 1. Sample pesticides containing carboxylic acid functional groups that should display different solubility controls when protonated or deprotonated and paired with metals.

FIG. 2. 2,4D release rates from metal hydroxide-containing formulations. Unexpectedly, the more soluble Ca(OH)2 formulation releases more slowly than the less soluble Mg(OH)2 formulation.

FIG. 3. 2,4D release rates from coated metal hydroxide-containing formulations. Coating the tablets provides another method for further controlling release rates beyond metal pairing.

FIG. 4. Na-2,4D release rates in the presence of CaCl2 and CuSO4. The presence of divalent metal ions significantly slows release rates.

FIG. 5. 2,4D release rates from metal-hydroxide containing tablets with and without added CuSO4. Addition of copper ions significantly slows release rates.

FIG. 6. 2,4D release rates from tablets exposed to water turnover. Every two hours, water was siphoned out and fresh 1 L of deionized water was added to mimic the water column turning over during a treatment. This procedure was carried out for the first eight hours.

FIG. 7. Expanded timeline of experiment outlined in Example 4 and shown in FIG. 6. Identity and ratio of metal hydroxides can be used to tune release rates of active ingredient. Ca(OH)2 provides release control out to 72 hours.

FIG. 8. Comparison of commercial granular formulation (Sculpin® G) release rates to 2,4D-metal hydroxides. Tableted granular formulation also released quickly. One water turnover was performed at the two hour mark for commercial formulations and four water turnovers were performed for 2,4D-metal hydroxides.

FIG. 9. Cumulative percent 2,4D released from Sculpin® G compared to new 2,4D-metal hydroxide formulations. Commercial formulation released all 2,4D within four hours, whereas 2,4D metal hydroxide formulations can be tuned to release between 6 and 72 hours.

FIG. 10. 2,4D release rates from optimized formulations compared to Sculpin® G. Data presented are an average of five trials at 20° C. in 1 L of deionized water stirred at 60 rpm. Results demonstrate ability to readily tune 2,4D release rate profiles.

FIG. 11. 2,4D release rates from new formulations compared to Sculpin® G in a flow through cell. Data presented are an average of two trials at 20° C. during the first 24 hours. Results demonstrate the ability to better control and maintain 2,4D concentrations in flowing water.

FIG. 12. 2,4D release rates from new formulations compared to Sculpin® G in a flow through cell. Data presented are an average of two trials at 20° C. Results demonstrate the ability to better maintain 2,4D concentrations in flowing water. Peak at 60 hours is attributable to pump tubing malfunction.

FIG. 13. Triclopyr release rates from new formulations. Data presented are an average of five trials at 20° C. in 1L of deionized water stirred at 60 rpm. Results demonstrate the ability to readily control triclopyr release rates.

FIG. 14. Triclopyr release rates from new formulations in a flow through cell. Data presented are an average of two trials at 20° C. Results demonstrate the ability to readily tune release rates and maintain triclopyr concentrations in flowing water.

FIG. 15. Triclopyr release rates from new formulations in a flow through cell. Data presented are an average of two trials at 20° C. Concentration increase at 120 hours for C is attributable to pump tubing malfunction. Results demonstrate the ability to readily tune release rates and maintain triclopyr concentrations in flowing water for up to one week.

FIG. 16. 2,4D release rates from tablets containing prereacted 2,4D compounds. Data presented are an average of two trials at 20° C. Results demonstrate that release rates are dependent upon the identity of the metal partnered with the 2,4D.

FIG. 17. 2,4D release rates from tablets containing 2,4D and different metal containing salts. Data presented are an average of two trials at 20° C. Results demonstrate that release rates depend upon identity of paired metal.

FIG. 18. 2,4D release rates from copper containing formulations. Data presented are an average of two trials at 20° C. Results demonstrate that release rate is highly dependent upon the state of the herbicide, state of the associated metal and the resulting strength of the attractive interaction.

FIG. 19. 2,4D release rates from calcium containing formulations. Data presented are an average of two trials at 20° C. Results demonstrate that release rate is highly dependent upon the state of the herbicide, state of the associated metal, and the resulting strength of the attractive interaction.

FIG. 20. Triclopyr release rates from tablets containing prereacted triclopyr compounds. Data presented are an average of two trials at 20° C. Results demonstrate that release rates are dependent upon the identity of the metal partnered with the triclopyr.

FIG. 21. Triclopyr release rates from tablets containing triclopyr and different metal containing salts. Data presented are an average of two trials at 20° C. Results demonstrate that release rates depend upon identity of paired metal.

FIG. 22. 2,4D release rates from Sculpin® G in deionized water and 0.1 molar calcium chloride. Results demonstrate that salts can be used to control release rates of existing commercial formulations.

FIG. 23. 2,4D percent released rates from different metal hydroxides and weight modifiers (bentonite or gypsum) in 2 L of stirred deionized water (60 rpm). Results demonstrate that release rates can be modified using different metal hydroxides weight modifiers.

FIG. 24. 2,4D percent released rates from different metal salts and weight modifiers (bentonite or gypsum) in 2 L of stirred deionized water (60 rpm). Results demonstrate that release rates can be modified using different metal salts and weight modifiers.

FIG. 25. Endothall percent released rates from different metal salts in 1 L of stirred deionized water (60 rpm) over 24 hours. Results display signs of significant alterations to release rates based upon metal choice.

FIG. 26. Endothall percent released rates from different metal salts in 1 L of stirred deionized water (60 rpm) over 72 hours. Results display signs of significant alterations to release rates based upon metal choice.

FIG. 27. Active ingredient percent release rates from tablets containing 33% copper-endothall salt and 33% Mg(2,4D)2 or 33 weight percent Ca(2,4D)2. Circle data markers are endothall concentrations stemming from the copper-endothall salt. The legend endothall label (Endo) links it to the corresponding 2,4D salt. Results are an average of three trials and demonstrate the ability to release multiple active ingredients at different rates from the same tablet.

FIG. 28. Active ingredient percent release rates from tablets containing 33% copper-endothall salt and 33% Mg(triclopyr) 2 or 33% Ca(triclopyr)2. Circle data markers are endothall concentrations stemming from the copper-endothall salt. The legend endothall label (Endo) links it to the corresponding triclopyr salt. Results demonstrate the ability to release multiple active ingredients at different rates from the same tablet.

FIG. 29. Imazamox percent release rates from different metal hydroxides or premade copper-imazamox salt. Results demonstrate that different metals provide for different release rates. Unlike 2,4D and triclopyr, metals increase the release rate of Imazamox.

FIG. 30. Benzoic acid percent release rates from different premade benzoic acid salts. Results demonstrate that different metals provide for different release rates. Unlike 2,4D, the Ca(BA)2 releases significantly faster than the neutral benzoic acid.

FIG. 31. Copper percent release from formulations containing alkyl carboxylates. Increasing the alkyl chain length of the paired carboxylate provides control over copper release rate.

FIG. 32. 2,4D release rates from BIODAC® granules loaded with 2,4D salts. Results demonstrate that metal interactions are also observed when loaded onto preformed carriers rather than tableting.

FIG. 33. 2,4D salts were applied to a bed of sand, then repeatedly flushed with deionized water to model frequent water exposure in a terrestrial application.

FIG. 34. Tablets from Example 6B were stored in a dehydrator at 135° F. and removed at designated intervals to determine the impact of heat on long term stability. Release rates remain the same within error.

FIG. 35. Tablets from Example 7B were stored in a dehydrator at 135° F. and removed at designated intervals to determine the impact of heat on long term stability. Release rates remain the same within error.

FIG. 36. Solubility of 2,4D and triclopyr ion pairs.

FIG. 37. Synthesis and yields of endothall salts.

### DETAILED DESCRIPTION OF THE INVENTION

Many pesticides contain functional groups that can be protonated or deprotonated to ionize the molecule and increase its water solubility. For example, the lampricide 3-trifluoromethyl-4-nitrophenol (TFM) is used to kill juvenile sea lamprey in spawning streams. TFM has an acidic phenol that when deprotonated, exhibits significantly increased water solubility. If a weak base is paired with the TFM, the solubilization of TFM can be controlled by the basicity and/or the solubility of the weak base. For example, alkaline earth metal hydroxides are weak bases with low solubility (e.g. Mg(OH)₂:Kₛₚ=1.8×10⁻¹¹, Ca(OH)₂:Kₛₚ=6.5×10⁻⁶). When TFM is paired with bases of increasing solubility, release rates increase from Mg(OH)₂<Ca(OH)₂<<<KOH. In this system, as solubility of the base increases, so too does the release rate of the TFM. With this knowledge in hand, we sought to apply this method to control release rates of 2,4-dichlorophenoxyacetic acid (2,4D), which is a widely used herbicide that bears an acidic carboxylic acid functional group. Unexpectedly, release rates did not correlate with the solubility of the paired base. Instead, when Mg(OH)₂ is paired with 2,4D, it releases significantly faster than when Ca(OH)₂ is paired with 2,4D. Solubilization of the 2,4D appears to be governed by metal identity rather than solubility of the paired base. Once the carboxylic acid is deprotonated, the resulting carboxylate can pair with the metal where the corresponding solubility is dependent upon the identity and oxidation state of the metal.

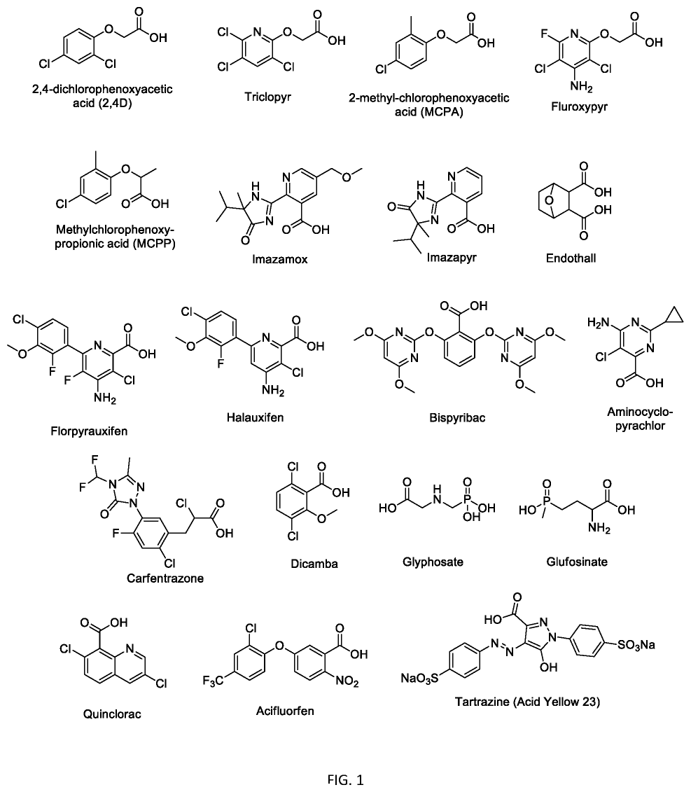

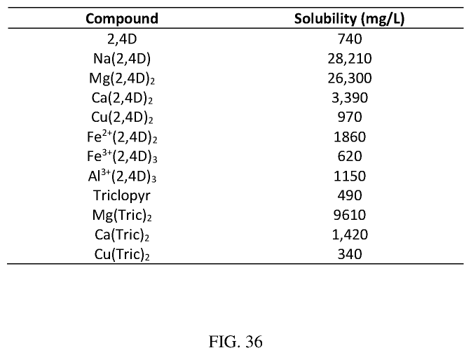

A series of 2,4D and triclopyr metal pairings were prepared to further elucidate the impacts of the metal identity and oxidation state on the solubility of the herbicide. For 2,4D, solubility decreases from Na⁺>Mg²⁺>Fe²⁺>Ca²⁺>Al³⁺>Cu²⁺>Fe³⁺ as shown in FIG. 36. This trend is also observed for triclopyr, another carboxylic acid containing pesticide, with solubility decreasing from Mg²⁺>Ca²⁺>Cu²⁺. These solubility profiles provide a variety of avenues to easily modify the solubility of carboxylic acid and carboxylate containing molecules in water and subsequently, their release rates. FIG. 1 provides the structures of carboxylic acid containing herbicides of interest as well as an aquatic dye. Representative carboxylic acid containing herbicides include, but are not limited to, 2,4D, triclopyr, 2,-methyl-chlorophenoxyacetic acid, fluorxypyr, methylchlorophenoxypropionic acid (MCPP), imazamox, imazapyr, imazapic, imazethapyr, imazaquin, endothall, florpyrauxifen, halauxifen, bispyribac, aminocyclopyrachlor, carfentrazone, dicamba, glyphosate, glufosinate, quinclorac, and acifluorfen. Other carboxylic acid containing molecules are used aquatically as well, such as tartrazine, which is a dye used to block specific wavelengths of sunlight. These herbicides are used to treat many different types of aquatic plants, such as, but not limited to, watermilfoils, hydrilla, cattail, water hyacinth, torpedo grass, purple loosestrife, elodea, curlyleaf pondweed, phragmites, water lettuce, and others. Improving the release rate profiles of these herbicides to optimize their CET in aquatic systems will carry significant environmental benefits as these nuisance aquatic plant species cause problems in many different water bodies, including irrigation canals. These approaches can also be used to treat terrestrial plants where frequent exposure to water occurs. This technology could also be applied to 4-(2,4-dichlorophenoxy)butanoic acid, aminopyralid, benazolin, clopyralid, cyhalofop acid, dichloroprop, difluenzopyr, fluazifop-P, flumiclorac, fluoroglycofen acid, haloxyfop, 4-(4-chloro-2-methylphenoxy)butanoic acid (MCPB), mecoprop, naptalam, pelargonic acid, picloram, and quinzalofop-P. or any other carboxyl-containing pesticide.

In this method, a carboxylic acid or a carboxylate containing active ingredient is paired with the appropriate metal-containing ingredient. The carboxylic acid or carboxylate consists of a carbonyl immediately adjacent to an oxygen atom. These oxygen atoms can be protonated or deprotonated. Other carbonyl-containing functional groups, such as esters and amides, can be used as well. The metal and oxidation state of the metal can be varied to achieve desired release rates. Other metals than those listed in FIG. 36 can be used as well, such as, zinc, manganese, molybdenum, cobalt, strontium, barium, lanthanum or any other applicable metal. Oxidation states can vary, for example, between +1 and +8. Choosing the correct pairing will produce an optimal reaction rate and/or solubility to maximize efficacy of the herbicide of interest. The ratio between herbicide and metal can also be varied to achieve ideal solubility and release rate profiles. The chosen metal can also have a nutrient or toxicant effect as well, to achieve synergistic effects. Because functional groups, like carboxylic acids and carboxylates, exhibit common properties regardless of the molecule to which it is attached (e.g. acidity/basicity, strength of interactions with metals, polarity, etc.), the user of this method can reliably predict that any carboxylic acid or carboxylate containing compound will exhibit solubility trends that are dependent upon the identity of the paired metal containing compound. The user need only to study the solubility profiles and release rates for each different combination, such as those shown in FIG. 36, but for the other pesticides listed in FIG. 1. Therefore, this method enables the user to control release rates of any carboxylic acid or carboxylate containing compound exhibiting some degree of water solubility. Examples discussed below demonstrate this practice for 2,4D, triclopyr, endothall, imazamox, benzoic acid and copper.

In another preferred embodiment, existing registered herbicide salts can be coupled with metal salts to moderate release rates from liquid or solid formulations. For example, 2,4D is commonly used as the 2,4D amine salt, wherein the 2,4D carboxylate is paired with a dimethylammonium ion. The 2,4D amine salt could be blended into a solid or liquid formulation with appropriate ratio of a salt such as copper sulfate pentahydrate, calcium chloride, calcium acetate, calcium citrate, calcium sulfate, calcium stearate, calcium tartrate, magnesium chloride, magnesium stearate, magnesium citrate, magnesium tartrate, aluminum chloride, aluminum sulfate, iron chloride, or any other salt of interest, that would lead to different release rate characteristics and/or synergistic effects. This method is applicable to many other pesticides as well. Triclopyr is used as the triethylamine salt, where the carboxylate of triclopyr is paired with a triethylammonium ion. Endothall dicarboxylates are paired with potassium or ammonium ions. Imazamox is used as the ammonium salt. Imazapyr is used as the isopropylammonium salt. Bispyribac is used as the sodium salt. Glyphosate can be in the isopropylammonium salt form. Dicamba is commonly used with various ammonium salts. Aminocyclopyrachlor is used as the potassium salt. Quinclorac is used as the dimethylammonium salt. Acifluorfen is used as the sodium salt. The described method of pairing an active ingredient with an appropriate salt could be applied to these herbicides or any other pesticide in a carboxylate or carboxylic acid form to moderate release of the pesticide at the desired rate. This combination can occur at any point during the manufacturing and/or application processes.

Neutral carboxylic acids can also exhibit changes in their release rate profiles when paired with a metal-containing compound. For example, pairing 2,4D with copper sulfate pentahydrate in a tablet form leads to slower release rates than either 2,4D or copper sulfate on their own. Other metals could be used in place of copper to either speed or slow release rates of the neutral 2,4D. The same process can also be applied to other carboxylic acid containing pesticides. These attractive interactions arise from Lewis acid-base pairings and would also be expected to occur in other carbonyl containing functional groups, such as amides.

Other methods exist for creating ion pairs with carboxylic acids through the use of non-metal containing weak bases. For example, carboxylic acids can be deprotonated with amines, ureas, carbonates, bicarbonates, nitrates, nitrites, sulfates, phosphates, acetates and cyano-containing groups. A base from this group with low solubility, for example octylamine, could be paired with a carboxylic acid containing active ingredient to yield an ion pair with a lower solubility than a dimethylamine or isopropyl amine. Furthermore, a carboxylic acid containing pesticide can be paired with a weak-base containing pesticide to create a synergistic herbicide combination leading to an ion pair with a more optimal release rate profile.

The methods described herein can be used to control release rates of any carboxyl-containing molecule of interest. These combinations can be used in liquid forms as a concentrate or can be a part of solid formulations. Developing solid formulations can be more challenging to manufacture than liquid formulations. However, solid formulations can increase root uptake by the target plant, so improvements for manufacturing will facilitate treatment efficacy. The carriers for the solid formulations can be based upon clays, silicates, gypsum, carbonates, sulfates, silts, sands, soluble salts, polymers and the like. The carrier can be designed to dissolve with the active ingredient, remain intact when the active ingredient leaves the carrier, or a combination of the two. The carrier can also be of a design to degrade in a soil environment. This approach provides for a range of weight percents of active ingredient to suit the desired application ranging from less than one percent by weight to approaching ninety nine percent by weight. In some applications, lower weight percents are desirable, whereas in others, higher weight percent active ingredient is desirable to minimize the total weight needed for an application. This new methodology is particularly applicable to solid formulations because they are readily modified and optimized. They can be applied to existing granules, blended and extruded, tableted, pelletized, compacted or any other method currently used to prepare a solid carrier formulation. BIODAC®, which is a cellulose-based carrier comprised of clay, paper fiber and calcium carbonate, has proven to be a very useful granule for carrying herbicides. BIODAC® can also be loaded with compositions disclosed herein to achieve new release rate profiles. The carrier choice itself can also impart control over release rates. For example, a swellable clay (such as bentonite) can lead to faster release rates. Gypsum is a mineral with low solubility, but can release the active ingredient at intermediate rates, whereas inert carriers (like silt) can slow release rates further because it takes time for the active ingredient to diffuse out of the carrier. Combinations of carriers can also be employed to achieve desired processing and application performance. Solvents, binders, lubricants (such as magnesium stearate), and other necessary tableting or compaction ingredients can also be used to aid manufacturing.

This chemistry is particularly useful for herbicides used in the treatment of aquatic plants in lakes, rivers, streams, marshes, wetlands, tidal areas, canals, irrigation canals, rice paddies, cranberry bogs, or any other location where an aquatic herbicide is needed. It is also applicable to terrestrial applications where frequent watering may lead to rapid dilution and transport of active ingredients from the target. Terrestrially, ion pair formation carries the additional benefit of reducing the vapor pressure, which reduces off site drift and potential harm to non-target species. Off site drift is a particular challenge for herbicides like dicamba, where volatilization and winds can carry it to neighboring fields leading to significant crop losses.

An added attribute of this method is the potential for synergistic effects resulting from the combination of the carboxylic acid containing molecule and the metal. For example, synergistic effects have been observed for 2,4D with aluminum, copper or calcium, and endothall with copper. These synergistic effects can include more effective treatment of the target, or can include a secondary benefit, such as water clarification, as can occur with aluminum containing compounds.

Carboxylates are known to produce network solids when mixed with multivalent metal ions. The carboxylates can coordinate the metal ions in either bridging or non-bridging fashions. The conditions of the synthesis can lead to different structures and impact whether the resulting solid is a hydrate or anhydrous. Applying this to pesticides containing carboxylates provides a new mode of controlling release rates through changes in the structures and metal ion identity. While a trend should be expected with different metal ions, in practice it cannot be predicted because many variables ultimately govern the process. Furthermore, different kinetics can be expected if the metal ions and carboxylates are coupled prior to application or during application.

To elucidate these trends for a molecule of interest, one needs to measure their solubility as the relationship between the metal ions and their stoichiometric ratios to the carboxylate-containing pesticides are varied. For example, when a pesticide containing a single carboxylate is paired with multivalent metals, the ratio between the two would be expected to balance the charges and be (monocarboxylate)₂M²⁺, (monocarboxylate)₃M³⁺, (monocarboxylate)₄M⁴⁺, (monocarboxylate)₅M⁵⁺, (monocarboxylate)₆M⁶⁺, (monocarboxylate)₇M⁷⁺, and so on. If applied to a dicarboxylate, one would expect (dicarboxylate)M²⁺, (dicarboxylate)₃M³⁺², (dicarboxylate)₂M⁴⁺, (dicarboxylate)₅M⁵⁺², (dicarboxylate)₃M⁶⁺, (dicarboxylate)₇M⁷⁺², and so on. However, the presence of other ions or different stoichiometric ratios of the metal ions to the carboxylates can lead to different results as well.

Another embodiment of the invention enables the user to independently tune the release rates of paired herbicides within a solid carrier to optimize each component. For example, a contact herbicide, such as endothall typically has shorter CET profiles to be effective, whereas some systemic herbicides, like 2,4D or triclopyr, can benefit from longer CET periods. Coupling herbicides can lead to better treatment efficacy and is typically done by mixing liquid formlations. Our process enables the user to couple two or more carboxylic acid containing herbicides and independently modify their individual release rates to achieve better treatment efficacy. This level of control is not possible with current technologies unless the applicator precisely adds liquids to a water body at designated times and often requires reapplication to achieve longer CET profiles for one of the components. This process enables the user to achieve more controlled release rates while only necessitating a single application.

In another preferred embodiment, copper ions are paired with an appropriate alkyl carboxylate to control release rates for application as an algicide, fungicide, herbicide, molluscicide, or any other aquatic copper treatment.

This broadly applicable process will benefit pesticides that have tens of millions in annual sales. Additionally, the process for EPA registration of new products is costly and time intensive, particularly so for the registration of a new active ingredient. This process enables the user to reformulate existing EPA-approved active ingredients with EPA-approved inert ingredients, which will greatly streamline the registration process while achieving better product efficacy.

The following examples demonstrate the use of this method for a variety of active ingredients, including 2,4D, triclopyr, endothall, imazamox, copper and benzoic acid. These examples are meant to be instructive and clarifying, but are not limiting.

### EXAMPLES

### Example 1

Preparation and release rates of 2,4D from tablets with metal

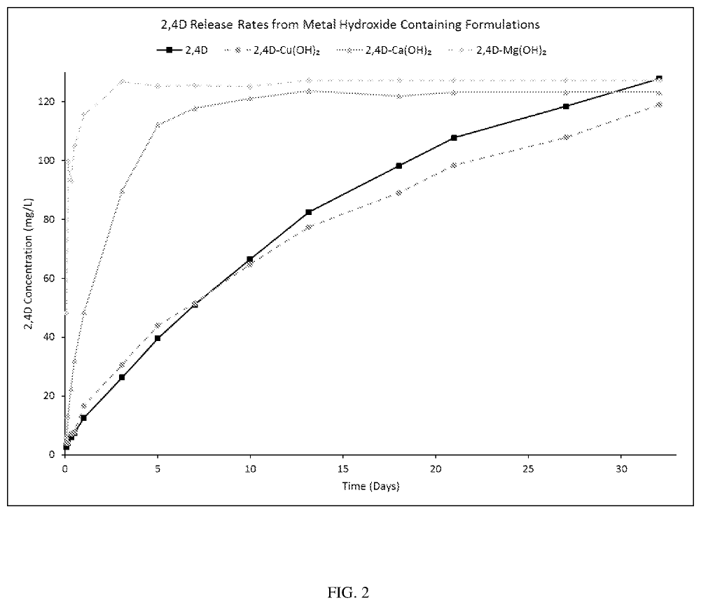

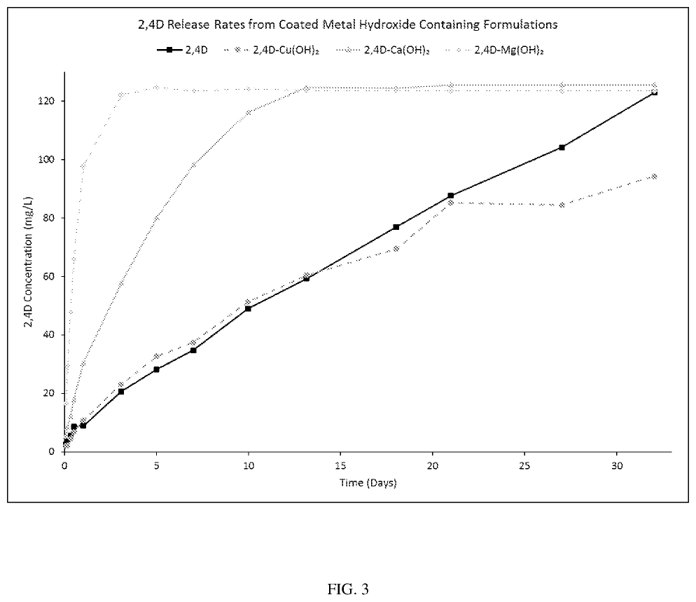

hydroxides. Tablets were prepared by blending 2,4D (5.0 g, 0.0227 mol), polyethylene glycol 3350 (1.5 g, PEG), sand (3.5 g) and a stoichiometric amount of metal hydroxide (0.0113 mol) in a mortar and pestle, and pressed into 8 mm tablets with a desktop tablet press. The resulting tablets were placed into jars containing 1 L of deionized water. The jars were swirled by hand for one cycle prior to sampling. The solubility of the hydroxides used are Ca(OH)₂>Mg(OH)₂>Cu(OH)₂. FIG. 2 displays the release rates. Unexpectedly, Mg(OH)₂ containing formulations release significantly faster than the more soluble Ca(OH)₂ formulation. If the rate of release was determined solely by the speed of deprotonation of the carboxylic acid, the 2,4D should be released in the same order as base solubility. This surprising discrepancy demonstrates that the identity of the metal it is paired with has a significant impact on solubility and subsequent release rates. Applying a semipermeable coating of blended sodium alginate and psyllium husk to the formulations produces the same trend, but with slowed release rates, which demonstrates that coatings can be used to further modify release rates (FIG. 3).

### Example 2

Preparation and release rates of 2,4D from tablets containing 2,4D carboxylate and calcium or copper salts.

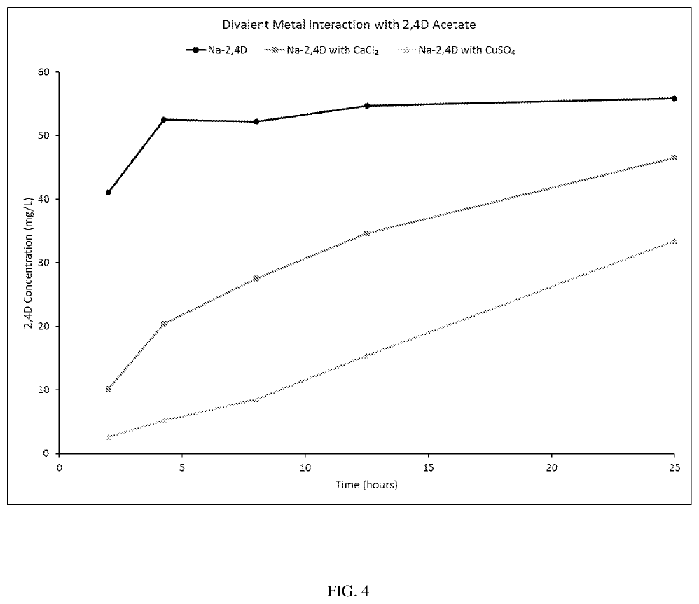

2,4D carboxylate is prepared through deprotonation of 2,4D with sodium methoxide to yield the sodium salt of 2,4D (Na(2,4D)). The Na(2,4D) carboxylate exhibits significantly higher water solubility than neutral 2,4D, as shown in FIG. 36. To further elucidate the effects of metal pairing, tablets containing a divalent metal salt and Na(2,4D) were prepared. Na(2,4D) (0.5 g, 0.0021 mol), PEG 3350 (0.15 g), sand (0.35 g), and a stoichiometric amount of divalent metal ion salt (0.0010 mol) were blended and pressed into 8 mm tablets. The resulting tablets were placed into jars containing 1 L of deionized water and stirred at 60 rpm. Sampling revealed that the presence of divalent ions markedly slowed release rates of the highly soluble Na(2,4D) (FIG. 4). Copper slowed release of 2,4D further than calcium, demonstrating the importance of the metal identity on controlling release rate. This approach could be used with existing ammonium salts of 2,4D, triclopyr, etc. to modify release rates of existing commercial formulations.

### Example 3

Preparation and release rates of 2,4D from tablets containing metal hydroxides and copper sulfate.

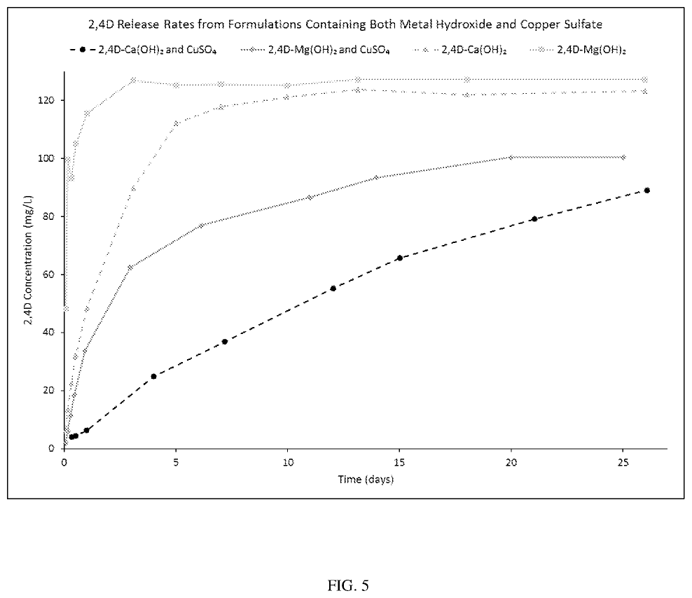

Tablets containing Ca(OH)₂ and Mg(OH)₂ were prepared as described in Example 1. For two control studies, a stoichiometric amount of copper sulfate pentahydrate (2.82 g, 0.011 mol) was added to the tablets to study how the simultaneous presence of two different metals impact release rates. Tablets were placed in 1 L jars and swirled once before each sample was removed for analysis. FIG. 5 shows that addition of copper to the formulation significantly slows release rates, further highlighting the importance of the metal identity in these attractive interactions.

### Example 4

Preparation and release rates of 2,4D from tablets exposed to water turnover.

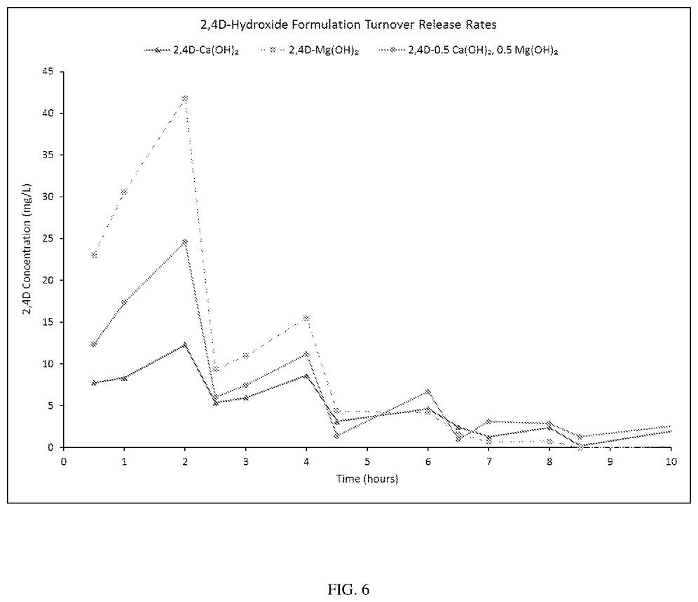

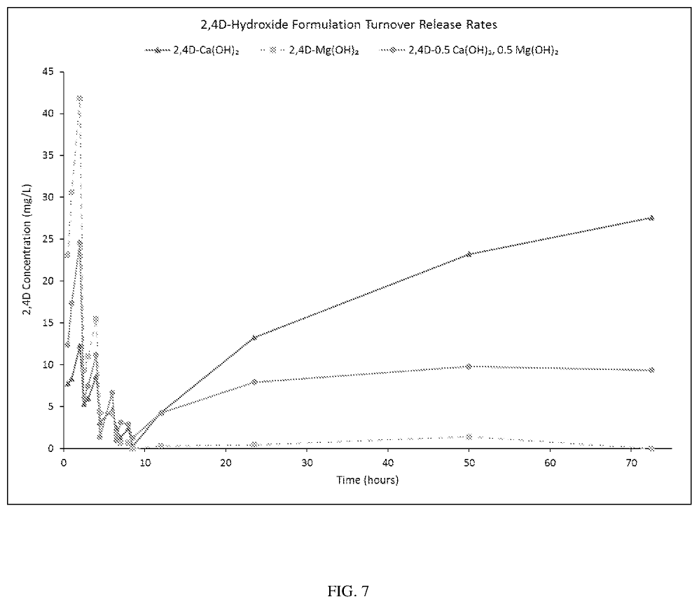

Tablets were prepared so that 2,4D was 17% by weight of the final formulation with a stoichiometric amount of added metal hydroxide. 2,4D (0.5 g, 0.00227 mol), metal hydroxide (0.00113 mol), 0.015 g magnesium stearate and silt (2.3 g) were blended in a mortar and pestle and pressed into 4 mm tablets using a desktop tablet press. The resulting tablets were immersed in 1 L of stirred deionized water (60 rpm). The water was siphoned out and replaced with a fresh 1 L deionized water every two hours during the first eight hours of the experiment to mimic the water column turning over in the field during a treatment. Results are an average of two trials and are shown in FIG. 6. The trends demonstrate that the Mg(OH)₂ formulation releases the fastest, followed by the 50:50 Mg(OH)₂:Ca(OH)₂ and lastly Ca(OH)₂. Furthermore, the formulations are able to restore 2,4D concentration in solution following addition of fresh water. The ability to replenish 2,4D is critically important to a successful treatment as efficacy improves when twelve or more hours of contact with active ingredient is achieved. FIG. 7 expands the timeline to further demonstrate that the identity and ratio of metal hydroxides provides control over release rates. These results show that this method of partnering a carboxylic acid containing pesticide with an appropriate metal containing ingredient provides a surprising and remarkably high level of control over release rates through simple formulation modifications, thus enabling the user to dial in the release rate profile to maximize treatment efficacy.

### Example 5

Release rates of 2,4D from commercial formulation.

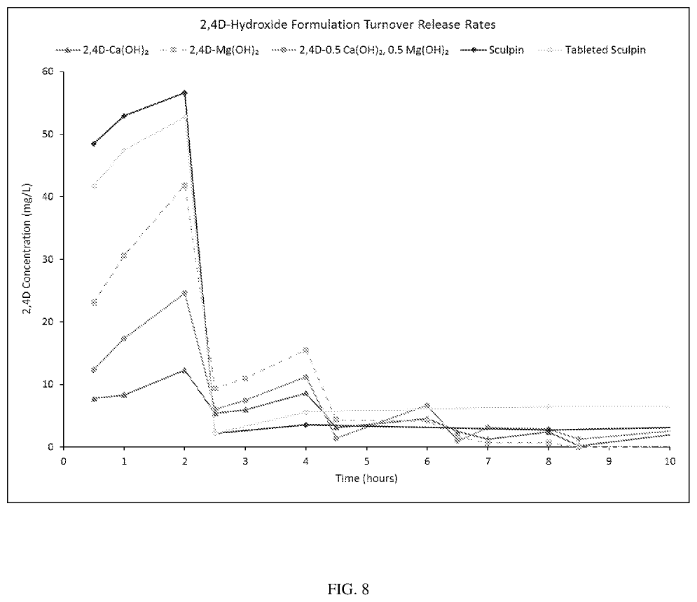

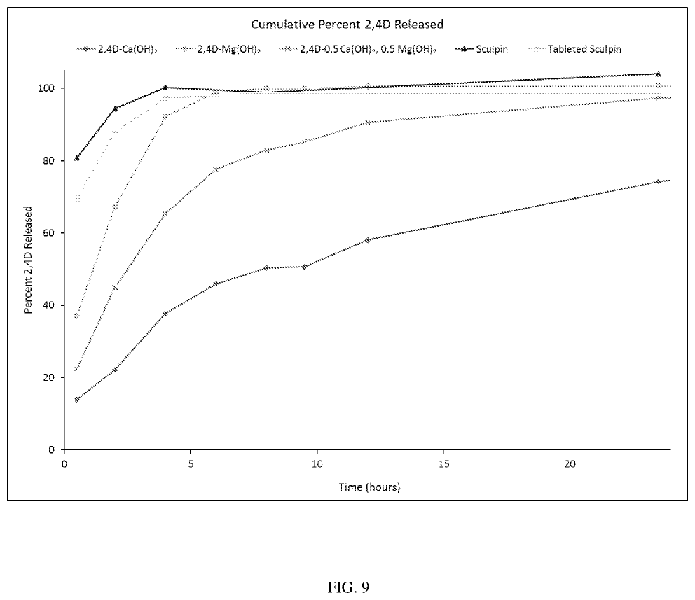

To compare the release rates of 2,4D-metal hydroxide formulations to standard granular 2,4D formulations, Sculpin® G was used as received and also ground into a powder, which was then pressed into tablets to study impact of tableting on release rate. These tablets were immersed in 1 L of stirred deionized water and underwent one water turnover at two hours. Following the two hour mark, nearly all 2,4D was exhausted based on calculations, so additional turnovers were not completed (FIG. 8). Results demonstrate that commercial formulation is unable to replenish active ingredient when the water column shifts. Comparing the cumulative percent 2,4D released versus time further corroborates that 2,4D metal hydroxide formulations provide remarkable control over 2,4D release rates when compared current granular formulations like Sculpin® G (FIG. 9). Furthermore, these results demonstrate this methodology enables a user to blend a faster releasing ingredient like Mg(OH)₂ with a slower releasing agent like Ca(OH)₂ to produce a formulation with a fast burst at the start of application followed by a slower prolonged release. These types of release profiles are very advantageous for optimal CET profiles.

### Example 6

Preparation and 2,4D release rates from optimized formulations containing 2,4D.

Tablets were prepared with 17% 2,4D by weight of the final formulation and a stoichiometric amount of added metal hydroxide. 2,4D (1.0 g, 0.00454 mol), metal hydroxide (0.00227 mol) and silt were blended and pressed into 6 mm tablets (average mass of 0.127 g/tablet) using a desktop tablet press. Surprisingly, it was found that no binders or lubricants were needed in tablet preparation, which led to a simpler formulation process and further demonstrates the importance of the metal-containing ingredient.

### Exact Formulations:

A. 1 g 2,4D, 0.13 g Mg(OH)₂, and 4.5 g silt
B. 1 g 2,4D, 0.066 g Mg(OH)₂, 0.084 g Ca(OH)₂, and 4.57 g silt
C. 1 g 2,4D, 0.17 g Ca(OH)₂, and 4.63 g silt

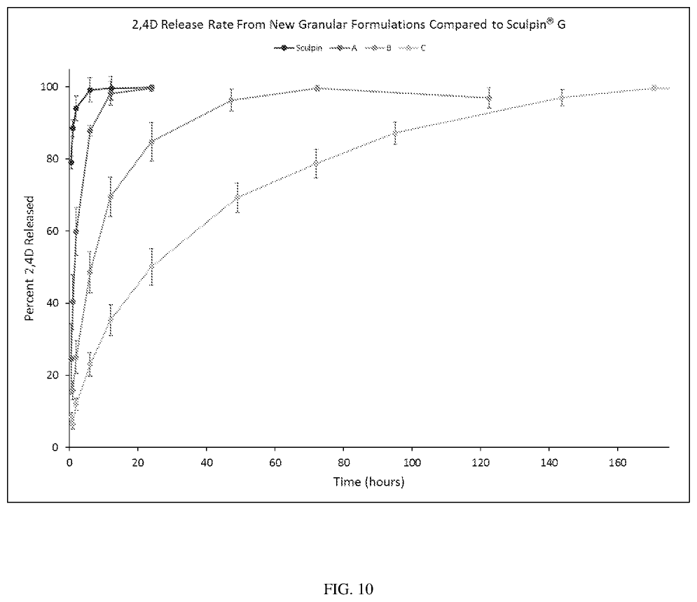

The resulting tablets were immersed in 1 L of stirred deionized water (60 rpm). Results in FIG. 10 are an average of 5 trials and demonstrate significantly slower release of 2,4D when compared to Sculpin® G, a commercial granular 2,4D formulation currently in use. The metal choice (Ca or Mg) influences release rates, with magnesium containing formulations releasing faster than calcium containing formulations. Blending the calcium and magnesium provides for release rates with a fast initial burst to 70% released in 12 hours followed by a slower release.

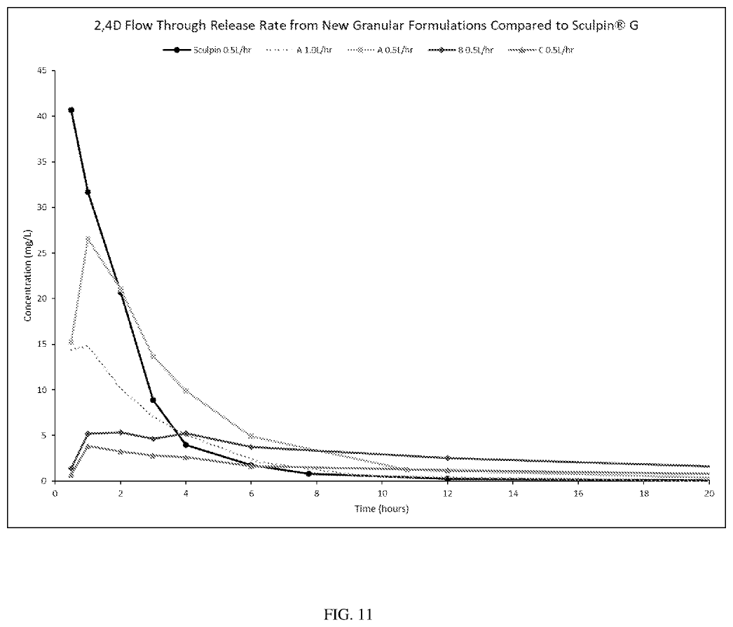

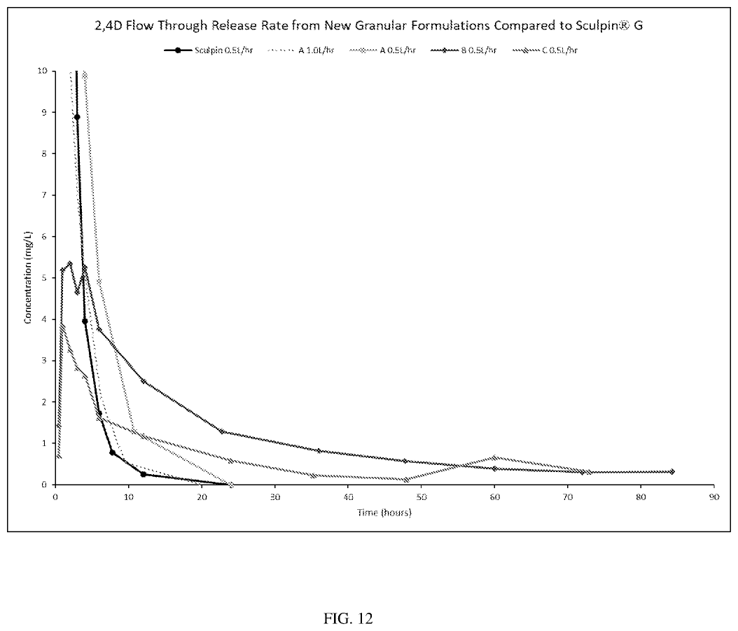

This control over release rate is further highlighted in FIGS. 11 and 12 where 2,4D containing formulations were studied in flowing water. Results are an average of two trials in which two tablets of formulations A, B, C, or Sculpin® G (containing equal amount of active ingredient) were placed into a 75 mL cell with a flow rate of 0.5 or 1.0 L/hr. Results show that commercial formulation reaches high concentration and is exhausted within 8 hours, whereas Ca or Mg containing formulations achieve a more sustained release. Additionally, higher flow leads to lower concentration; however, release times remain the same (A 1.0 L/hr vs. A 0.5 L/hr). FIG. 12 is an expanded timeline revealing release rates that last for days rather than hours. The release rate profiles shown support how incorporating metal-containing additives provides control over release rates of the active ingredient.

### Example 7

Preparation and release rates of triclopyr from optimized formulations.

Tablets were prepared so that triclopyr was 20% by weight of the final formulation with a stoichiometric amount of added metal hydroxide. Triclopyr (1.0 g, 0.00389 mol), metal hydroxide (0.00195 mol) and silt were blended and pressed into 6 mm tablets (average mass of 0.127 g/tablet) using a desktop tablet press.

### Exact Formulations:

A. 1 g Triclopyr, 0.114 g Mg(OH)₂, and 3.86 g silt
B. 1 g Triclopyr, 0.057 g Mg(OH)₂, 0.072 g Ca(OH)₂, and 3.84 g silt
C. 1 g Triclopyr, 0.144 g Ca(OH)₂, and 3.84 g silt

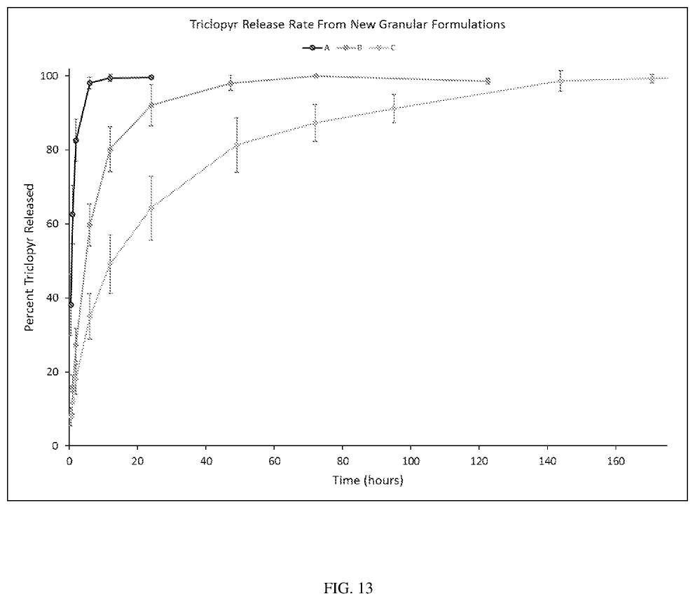

The resulting tablets were immersed in 1L of stirred deionized water (60 rpm). Results in FIG. 13 are an average of 5 trials and demonstrate that the metal choice (Ca or Mg) strongly influences release rates. Calcium containing formulations released more slowly than magnesium containing formulations. Furthermore, these results highlight that this simple methodology is effective for additional herbicides beyond 2,4D.

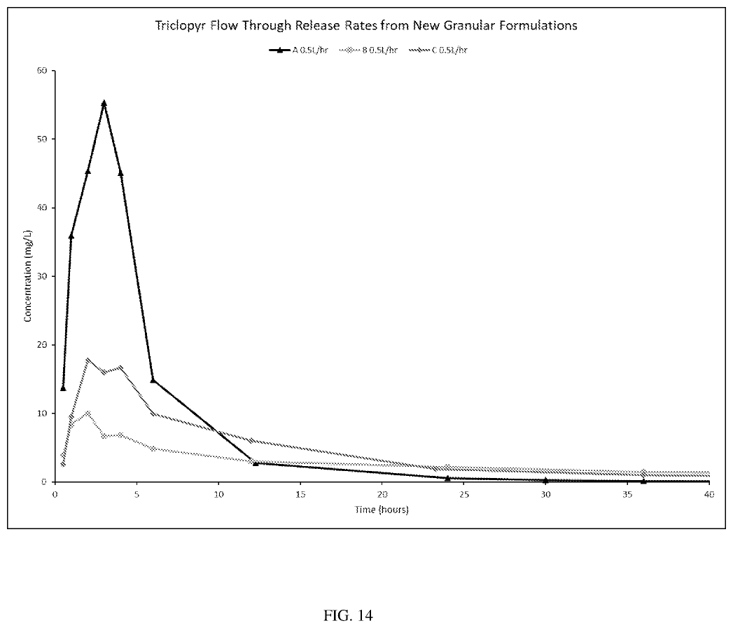

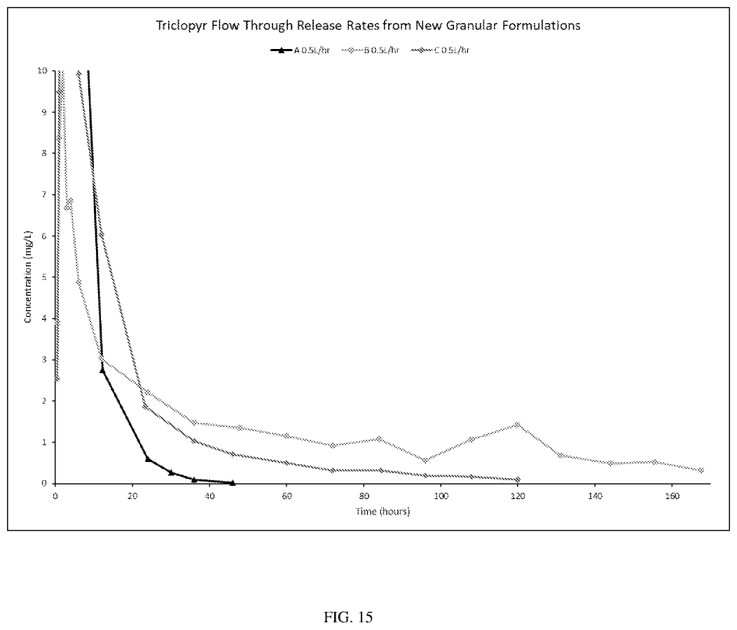

This control over release rates is also supported by data provided in FIGS. 14 and 15, in which triclopyr containing formulations were studied in flowing water. Plots shown are an average of two trials of formulations A, B or C where four tablets were placed into a 75 mL cell with a flow rate of 0.5 L/hr. Results show that formulations containing Ca or Mg exhibit controlled release in flowing water. FIG. 15 is an expanded timeline which shows that including metal cations in the formulation provides the ability to tailor release rates of the active ingredient.

### Example 8

Preparation and 2,4D release rates from tablets containing preformed 2,4D complexes.

2,4D complexes were prepared by combining a stoichiometric amount of 2,4D with the respective metal hydroxide or by blending the sodium 2,4D salt with the metal salt of choice in 20 mL of deionized water for 12 hrs. Iron (III) nitrate nonahyrate and Iron (II) chloride dihydrate were used to prepare the Fe(2,4D)₃ and Fe(2,4D)₂ complexes, respectively. The resulting solids were filtered and resuspended in deionized water with stirring for 15 min., then filtered again. The solids were dried to constant mass in a food dehydrator 120° F.

Tablets were then prepared by combining the dried 2,4D compound of interest with silt, and pressed into 6 mm tablets using a desktop tablet press to produce the following formulations with 20% 2,4D by weight.
A. 1 g 2,4D, 4 g silt
B. 1.1 g Na(2,4D), 3.9 g silt
C. 1.28 g Cu(2,4D), 3.72 g silt
D. 1.18 g Ca(2,4D), 3.82 g silt
E. 1.11 g Mg(2,4D), 3.89 g silt
F. 1.1 g Na(2,4D), 0.56 g CuSO₄, 3.34 g silt
G. 1.25 g Fe₂₊(2,4D), 3.75 g silt
H. 1.25 g Fe₃₊(2,4D), 3.75 g silt

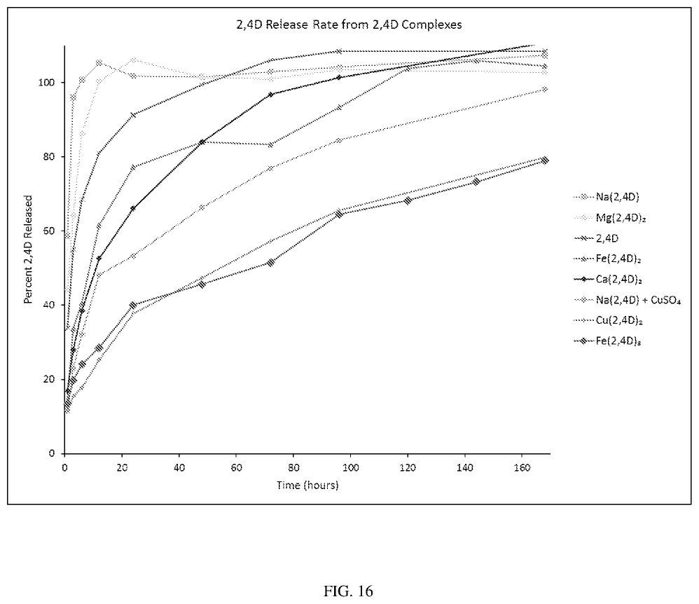

The resulting tablets were immersed in 1 L of deionized water at 20° C. and stirred at 60 rpm for the designated time period. 2,4D release rates are shown in FIG. 16. Results show that release rates are dependent upon the identity of the metal. Unexpectedly, the release rates do not perfectly align with the solubility of the 2,4D complexes. For example, in FIG. 36, the solubility of 2,4D is listed as 740 mg/L whereas Ca(2,4D)₂ is 3390 mg/L. Yet in FIG. 16, the neutral 2,4D releases significantly faster than the Ca(2,4D)₂. The same is true for Fe(2,4D)₂, which has a solubility of 1860 mg/L, yet releases more slowly than 2,4D.

### Example 9

Preparation and 2,4D release rates from tablets containing 2,4D and metal containing salts.

Tablets were prepared with 20% 2,4D by weight of the final formulation and a stoichiometric amount of metal salt. 2,4D, metal salt, and silt were blended together using a mini blender and then pressed into 6 mm tablets (average mass of 0.130 g/tablet) using a desktop tablet press.

### Exact Formulations:

A. 1 g 2,4D, 4 g silt
B. 1 g 2,4D, 0.670 g CaCl₂, 3.330 g silt
C. 1 g 2,4D, 0.431 g MgCl₂, 3.569 g silt
D. 1 g 2,4D, 1.13 g CuSO₄, 2.870 g silt

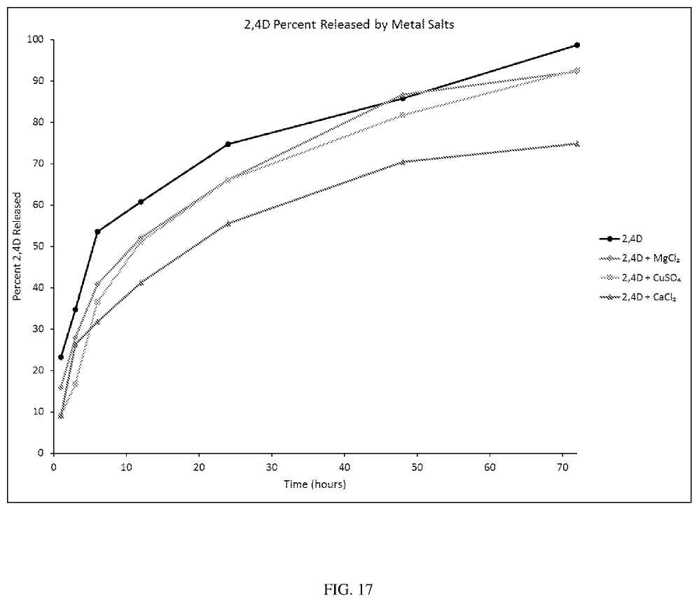

The resulting tablets were immersed in 1 L of stirred deionized water (60 rpm) at 20° C. Results in FIG. 17 displays percent 2,4D released from an average of two trials for each combination. The results demonstrate that a range of release rates occur based on the identity of the metal containing salt chosen for the formulation. Additionally, increasing the stoichiometric ratio of 2,4D to the metal containing salt from 1:1 to 2:1 produced a similar trend, where added salts reduced the release rate of 2,4D from the tablets.

### Example 10

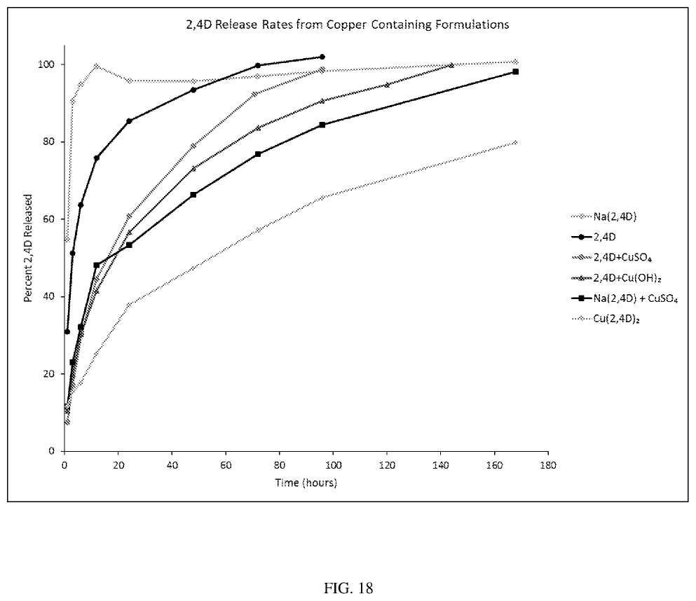

FIG. 18 overlays results from previous examples to directly compare how copper containing formulations provide different methods for obtaining precise control over 2,4D release rates. As expected, the Na(2,4D) released the fastest. Addition of CuSO₄ significantly slowed release rates with the premade copper complex being the slowest of all. Interestingly, when the Na(2,4D) was combined with CuSO₄, it provides a unique burst of 50 percent released in 12 hours, followed by a steady release.

### Example 11

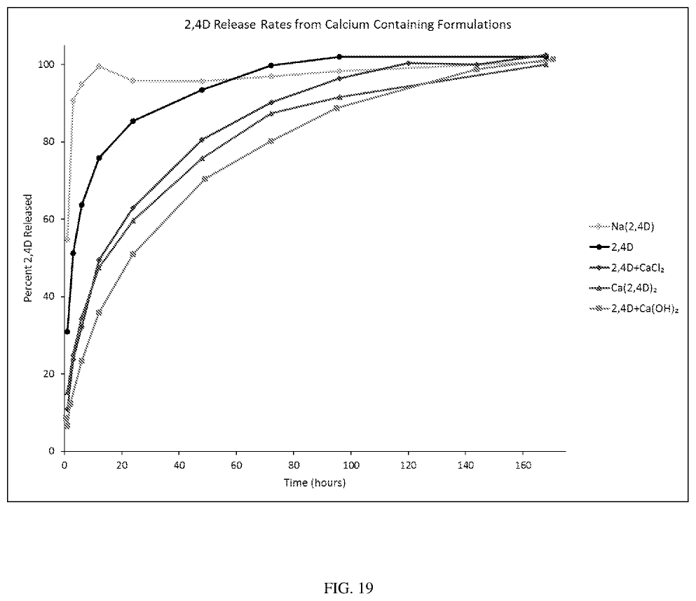

FIG. 19 overlays results from previous examples to directly compare how different calcium containing formulations provide different pathways and precise control over 2,4D release rates. As expected, the Na(2,4D) releases the fastest. Addition of calcium significantly slowed release rates. Unlike copper, however, the premade calcium complex is not significantly slower.

### Example 12

Preparation and triclopyr release rates from tablets containing triclopyr complexes.

The triclopyr salts were prepared by reacting 2.0 g of triclopyr with a stoichiometric amount of metal hydroxide in 25 mL of deionized water. The mixtures were stirred for a minimum of 12 hours. The resulting precipitates were then filtered, resuspended in 10 mL of deionized water and isolated through filtration. The final salt products were then put into a dehydrator set to 120° F. for 12 hours. The final products were mixed with silt to create a formulation that consisted of 20% triclopyr and then pressed into 6 mm tablets (average mass of 0.094 g/tablet) using a desktop tablet press.

### Exact Formulations:

A. 1.00 g triclopyr, 4 g silt
B. 0.211 g triclopyr (Mg), 0.789 g silt
C. 0.216 g triclopyr (Ca), 0.784 g silt

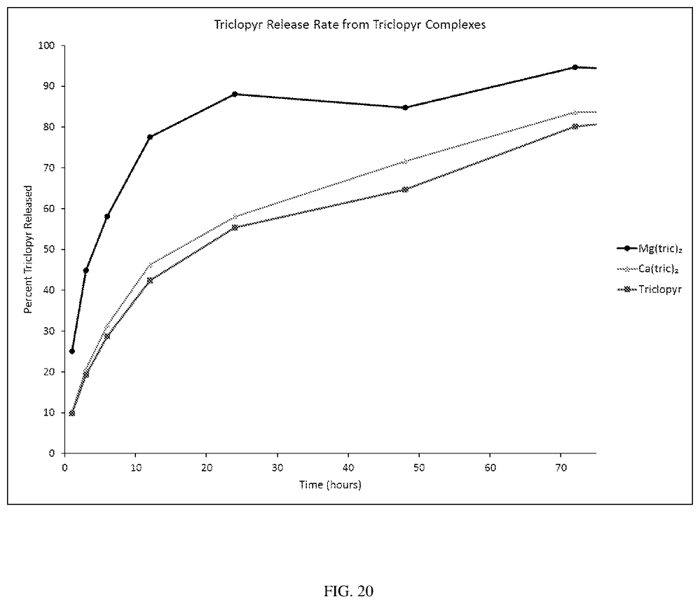

The resulting tablets were immersed in 1 L of stirred deionized water (60 rpm). FIG. 20 displays the averaged percent released of two trials and demonstrate how release rates depend upon the identity of the paired metal. Unlike with the prereacted 2,4D complexes where some released faster (Mg and Fe²⁺) and the rest released slower (Ca, Cu, Fe³⁺) than 2,4D alone, all of the prereacted triclopyr complexes released faster than the triclopyr alone, demonstrating that while coupling metals with carboxylic acids and carboxylates is systematic, variations occur between different active ingredients.

### Example 13

Preparation and triclopyr release rates from tablets containing triclopyr and metal containing salts.

Tablets were prepared with 20% triclopyr by weight of the final formulation and a stoichiometric amount of metal salt. Triclopyr, metal salt, and silt were blended together using a mini blender and then pressed into 6 mm tablets (average mass of 0.130 g/tablet) using a desktop tablet press.

### Exact Formulations:

A. 1 g triclopyr, 4 g silt
B. 1 g triclopyr, 0.573 CaCl₂, 3.427 g silt
C. 1 g triclopyr, 0.371 g MgCl₂, 3.629 g silt
D. 1 g triclopyr, 0.974 g CuSO₄, 3.026 g silt

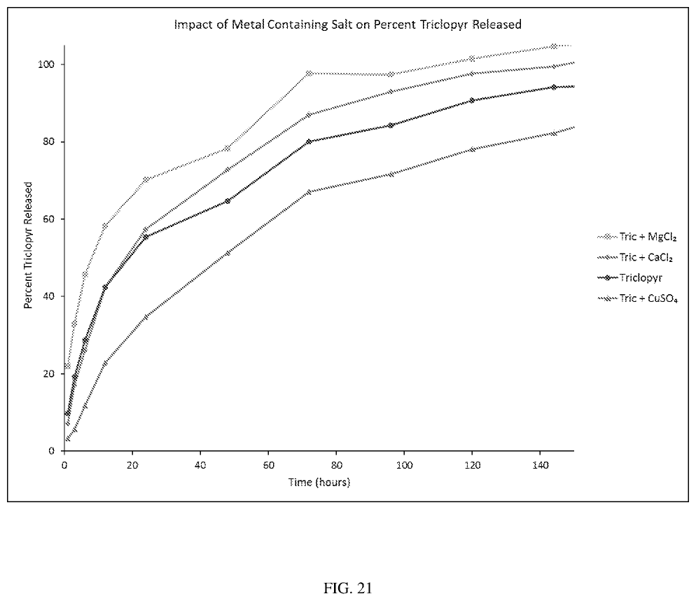

The resulting tablets were immersed in 1 L of stirred deionized water (60 rpm). Results in FIG. 21 display percent triclopyr released from an average of two trials for each combination. As shown, a range of release rates can occur based on which metal salt is present in a formulation. Unlike the 2,4D profile shown in FIG. 17 where all added salts slowed 2,4D release rates, magnesium chloride and calcium chloride accelerated triclopyr release rates whereas copper sulfate slowed triclopyr release.

Additionally, stoichiometric ratios between triclopyr and metal salts were increased to 2:1 respectively to see if the trend could be observed. The resulting data displayed similar trends as to what was observed in FIG. 21.

### Example 14

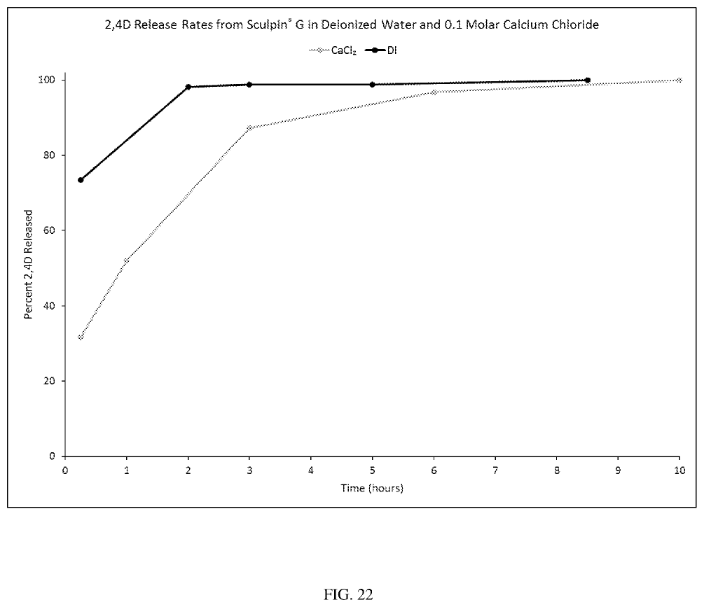

Sculpin® G was immersed in 1 L of stirred deionized water (60 rpm). Bottles contained either deionized water or 0.1 molar CaCl₂. Results are shown in FIG. 22, and demonstrate that salts can be used to regulate release rates of existing commercial formulations.

### Example 15

Preparation of optimized 2,4D formulations using alternative weight modifiers.

Tablets were prepared in the same manner as Example 6, but with bentonite or gypsum in place of silt. The amount of bentonite or gypsum in each formulation differed to ensure that each tablet had 20% 2,4D by weight and a stoichiometric amount of added metal hydroxide. 2,4D (1.0 g, 0.00454 mol), metal hydroxide (0.00227 mol) and bentonite/gypsum were blended and pressed into 6 mm tablets (average mass of 0.127 g/tablet) using a desktop tablet press.

### Exact Formulations:

A. 2 g 2,4D, 0.26 g Mg(OH)₂, 7.74 g bentonite or gypsum
B. 2 g 2,4D, 0.34 g Ca(OH)₂, 7.66 g bentonite or gypsum
C. 2 g 2,4D, 0.44 g Cu(OH)₂, 7.56 g bentonite or gypsum

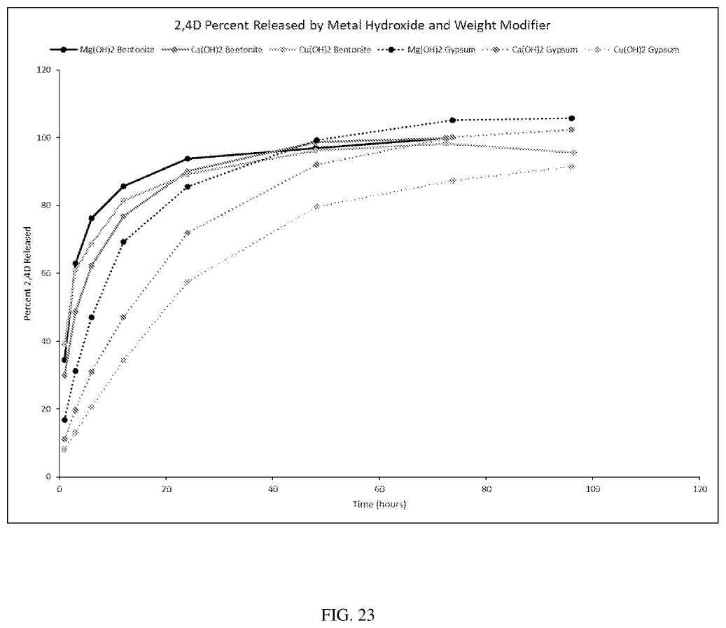

The resulting tablets were immersed in 2 L of stirred deionized water (60 rpm) with two tablets per bottle. Results in FIG. 23 are an average of 3 trials and demonstrate that this chemistry is compatible with multiple carriers, and that release rates can be altered by the metal identity as well as by the chosen weight modifier.

### Example 16

Preparation of optimized 2,4D salt formulations using alternative weight modifiers.

Metal 2,4D salts were prepared by combining 20 g of 2,4D with the stoichiometric amount of metal hydroxide in 0.3 L of deionized water and stirred for 12 hours. The resulting suspensions were filtered, resuspended in deionized water to wash the solids and then refiltered. The isolated metal 2,4D salts were then dried in a dehydrator for 48 hours at 160° F.

Tablets were prepared in the same manner as Example 15 with bentonite or gypsum in place of silt. Exact formulations:
A. 2.22 g Mg(2,4D)₂, 7.78 g bentonite or gypsum
B. 2.36 g Ca(2,4D)₂, 7.64 g bentonite or gypsum
C. 2.58 g Cu(2,4D)₂, 7.42 g bentonite or gypsum

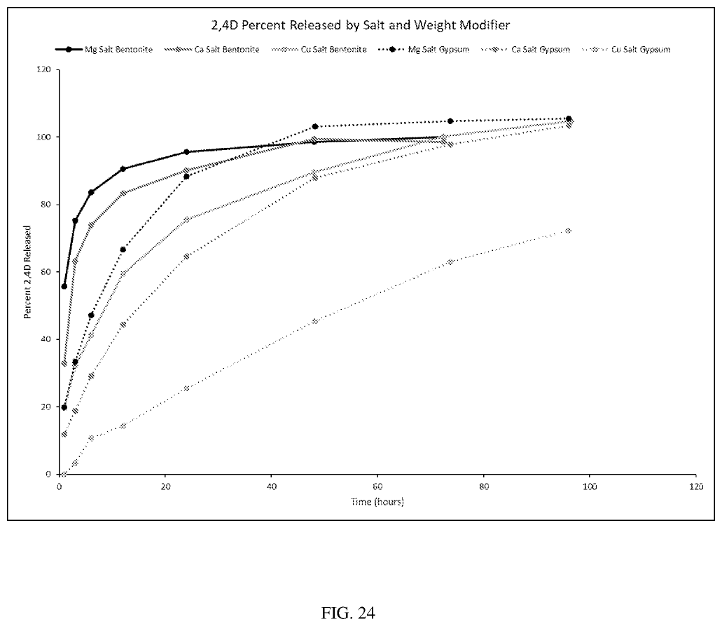

The resulting tablets were immersed in 2 L of stirred deionized water (60 rpm) with two tablets per bottle. Results in FIG. 24 are an average of 3 trials and further demonstrate that release rates can be altered by the paired metal as well as by weight modifiers.

### Example 17

Preparation of optimized endothall salt formulations

Endothall salts were prepared by adding 40 mL of Aquathol® to 50 mL of a salt solution in deionized water. Salts that were used for endothall precipitation included: MgCl₂, CaCl₂, CuSO₄·5H₂O, FeCl₂·4H₂O, and Fe(NO₃)₃·9H₂O. When Aquathol® was added to the respective salt solution, a precipitate formed. Following 30 minutes of stirring, the solids were isolated by filtration, washed with deionized water and refiltered. The solids were dried at 160° F. for 48 hours.

Tablets were then prepared with 44.7% endothall by weight of total formulation to match the existing granular formulation of Aquathol Super K®. The endothall salts were blended with silt and then pressed into 6 mm tablets (average mass of 0.106 g/tablet) using a desktop tablet press.

### Exact Formulations:

A. 5.005 g Mg-Endothall, 4.995 g silt
B. 5.384 g Ca-Endothall, 4.616 g silt
C. 5.947 g Cu-Endothall, 4.053 g silt
D. 5.763 g Fe-Endothall (amount used for Fe²⁺and Fe³⁺), 4.237 g silt

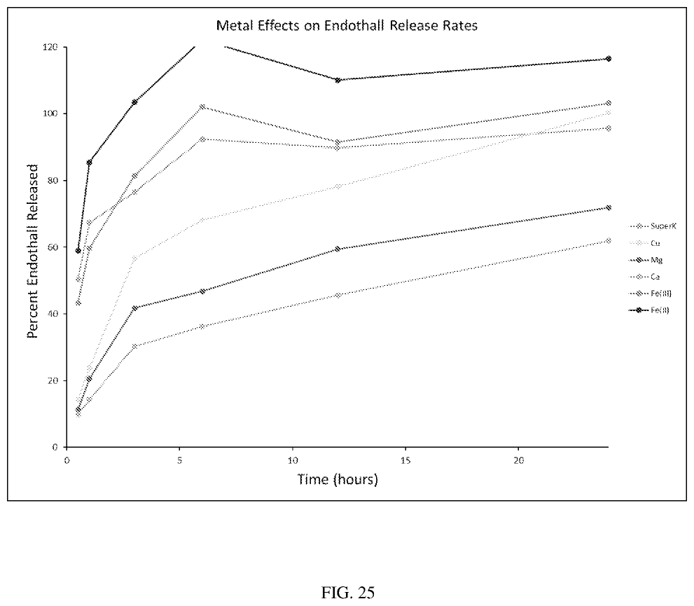

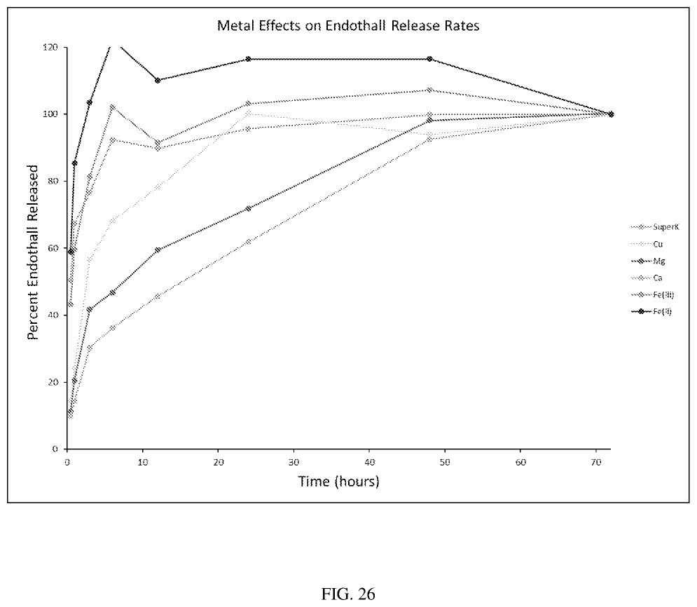

The resulting tablets were immersed in 3 L of stirred deionized water (60 rpm) with one tablet per bottle. Results in FIG. 25 are an average of 3 trials and demonstrate how release rate depends upon the paired metal. Unlike 2,4D, Fe³⁺and Fe²⁺both lead to faster release than magnesium and calcium. FIG. 26 demonstrates that controlled release of endothall extends beyond 24 hours.

### Example 18

Preparation of and release rates from dual active ingredients for copper-endothall salt and Mg(2,4D)₂ or Ca(2,4D)₂.

Formulations were prepared with 33 weight percent each of copper-endothall salt, Mg(2,4D)₂ or Ca(2,4D)₂ salt, and silt. Formulations were mixed using a blender and then pressed into 6 mm tablets (average weight of 0.082 g/tablet) using a desktop tablet press. Exact Formulations:
A. 0.5 g Endothall (Cu), 0.5 g 2,4D (Ca), 0.5 g silt
B. 0.5 g Endothall (Cu), 0.5 g 2,4D (Mg), 0.5 g silt

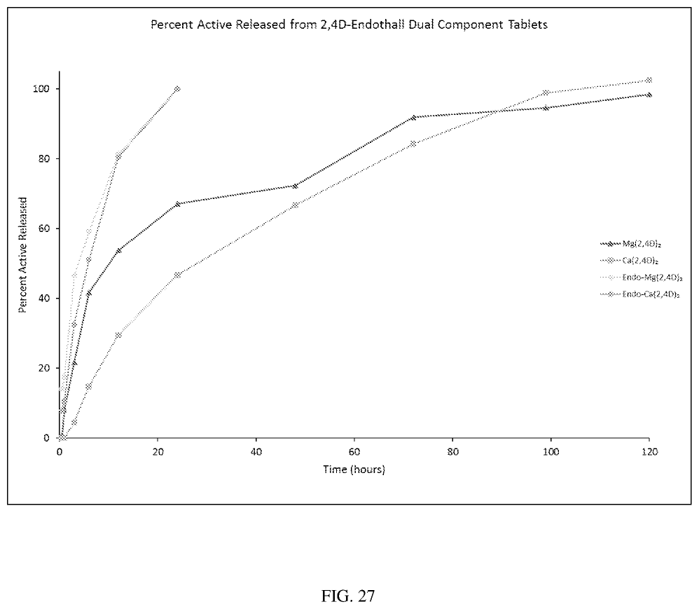

The resulting tablets were immersed in 1 L of stirred deionized water (60 rpm). Results are an average of three trials and demonstrate that the release rates of individual components can be tuned independently, providing for precise control and optimal performance (FIG. 27). The copper endothall salt portion of the formulation releases rapidly within 24 hours for both formulations. The 2,4D portions of the formulation release faster for magnesium and slower for calcium, demonstrating the ability to modify one component at a time to achieve optimal CET.

### Example 19

Preparation of and release rates from dual active ingredients for copper-endothall salt and Mg(triclopyr)₂ or Ca(triclopyr)₂.

Formulations were prepared with 33 weight percent each of copper-endothall salt, Mg(triclopyr)₂ or Ca(triclopyr)₂ salt, and silt. Formulations were mixed using a blender and then pressed into 6 mm tablets (average weight of 0.082 g/tablet) using a desktop tablet press.

### Exact Formulations:

A. 0.5 g Endothall (Cu), 0.5 g triclopyr (Ca), 0.5 g silt
B. 0.5 g Endothall (Cu), 0.5 g triclopyr (Mg), 0.5 g silt

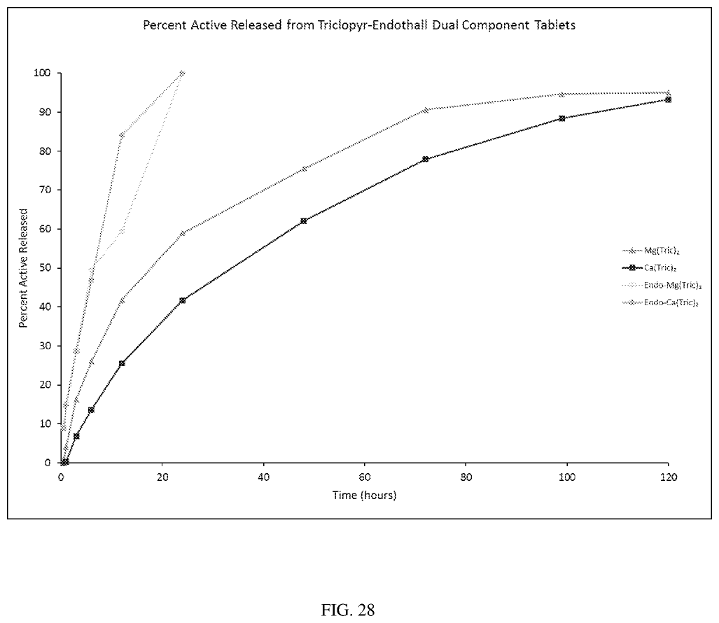

The resulting tablets were immersed in 1 L of stirred deionized water (60 rpm). Results are an average of three trials and demonstrate that the release rates of individual components can be tuned independently, providing for precise control and optimal performance (FIG. 28). The copper endothall salt portion of the formulation releases rapidly within 24 hours for both formulations. The triclopyr portions of the formulation release faster for magnesium and slower for calcium, demonstrating the ability to modify one component at a time to achieve optimal CET.

### Example 20

Preparation and release rates of imazamox with metal hydroxides.

Imazamox formulations were prepared by combining imazamox with a stoichiometric amount of metal hydroxide in a mortar and pestle, pressing into 6 mm tablets, and then immersing into 1 L, stirred (60 rpm), room temperature, deionized water to study the release rate profile of imazamox.

### Exact Formulations:

A. 0.2 g imazamox, 0.8 g silt
B. 0.2 g imazamox, 0.019 g Mg(OH)₂, 0.781 g silt
C. 0.2 g imazamox, 0.024 g Ca(OH)₂, 0.776 g silt
D. 0.2 g imazamox, 0.082 g CuSO₄, 0.718 g silt

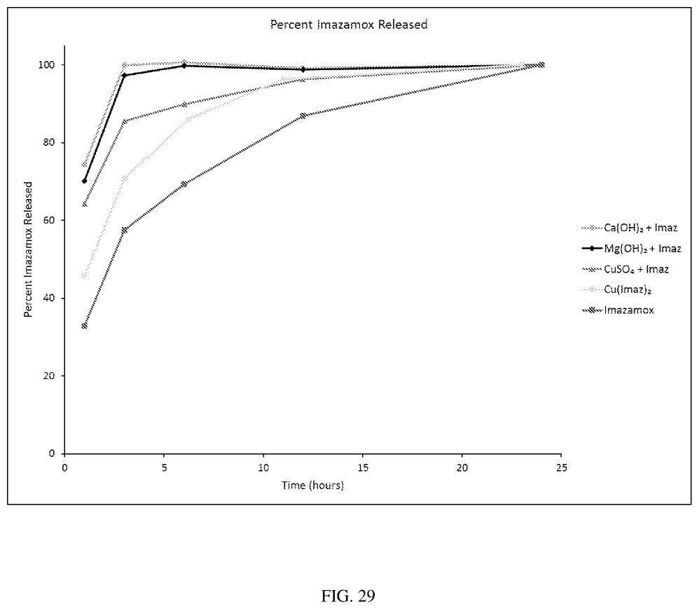

FIG. 29 displays the release rates and are an average of two trials. Unexpectedly, addition of metals, through either metal hydroxide, neutral metal, or premade imazamox-copper salt all increase release rates. This trend is counter to what is observed for 2,4D and triclopyr. Furthermore, calcium and magnesium hydroxide both release at nearly the same rates, whereas a significant difference is observed with these hydroxides for both 2,4D and triclopyr. These results demonstrate that while the identity of the metal controls release rates, each active ingredient must be studied independently to determine release rate profile. A trend can be expected, but not predicted.

### Example 21

Preparation and release rates of benzoic acid salts.

Benzoic acid (BA) is a structural analogue to dicamba with its carboxylic acid in the benzyl position. BA salts were prepared by mixing a stoichiometric amount of metal hydroxide with benzoic acid in deionized water for a minimum of 12 hours. The resulting solids were filtered out of solution and dried in a dehydrator for 12 hours at 120° F. These were then blended with silt in a mortar and pestle and pressed on a desktop tablet press into 6 mm tablets (average tablet weight 0.093 g).

### Exact Formulations:

A. 0.1 g BA, 0.4 g silt
B. 0.1 g Mg(BA)₂, 0.4 g silt
C. 0.1 g Ca(BA)₂, 0.4 g silt
D. 0.1 g Cu(BA)₂, 0.4 g silt
E. 0.1 g Na benzoate, 0.4 g silt

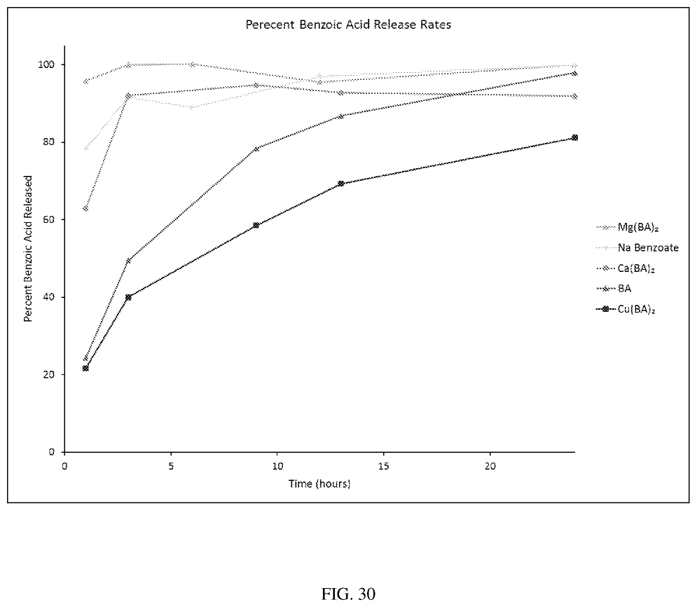

These tablets were immersed in 1 L, stirred (60 rpm), room temperature, deionized water with two tablets per jar. FIG. 30 displays results (average of two trials) and demonstrates that release rates depend upon the identity of the paired metal. Unlike 2,4D and triclopyr, Ca(BA)₂ releases significantly faster than BA, which demonstrates that while the identity of the metal controls release rates, each active ingredient must be studied independently to determine release rate profile. A trend can be expected, but not predicted. Based on this, a trend could also be expected when dicamba is paired with metal ions.

### Example 22

Preparation and release rates of copper from formulations containing alkyl carboxylates.

Tablets were prepared containing copper sulfate pentahydrate in silt or blended with sodium carboxylates to study the ability for carboxylates to slow copper release rates. CuSO₄ was mixed with sodium decanoate or sodium octanoate at stoichiometric ratios in a mortar and pestle and then pressed into 6 mm tablets on a desktop tablet press.

### Exact Formulations:

A. 0.393 g CuSO₄, 0.607 g silt
B. 0.393 g CuSO₄, 0.611 g sodium decanoate
C. 0.393 g CuSO₄, 0.523 g sodium octanoate

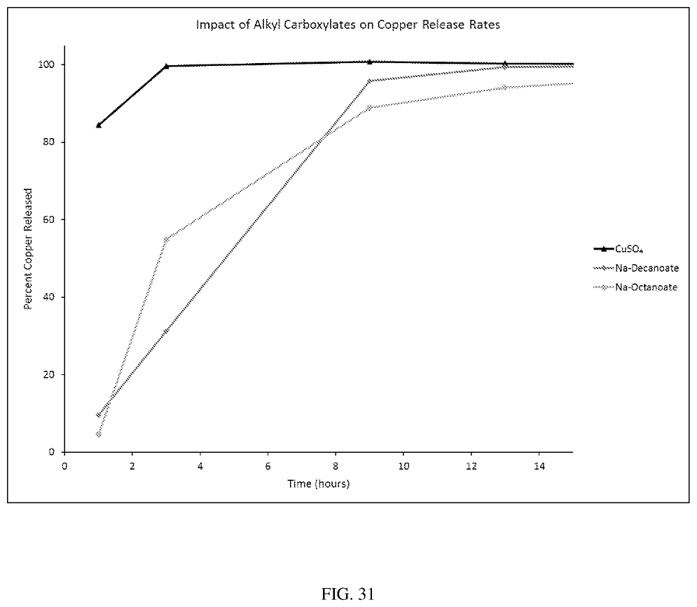

The resulting tablets were immersed in 1 L of stirred (60 rpm) deionized water at room temperature with two tablets per jar (average mass 0.218 g/jar). FIG. 31 displays the results (average of two trials) and demonstrates that adding carboxylates to copper sulfate significantly slows release rate. Furthermore, longer alkyl chains (decanoate) release slower than shorter (octanoate).

### Example 23

Preparation and release rates of 2,4D from BIODAC® granules loaded with 2,4D salts

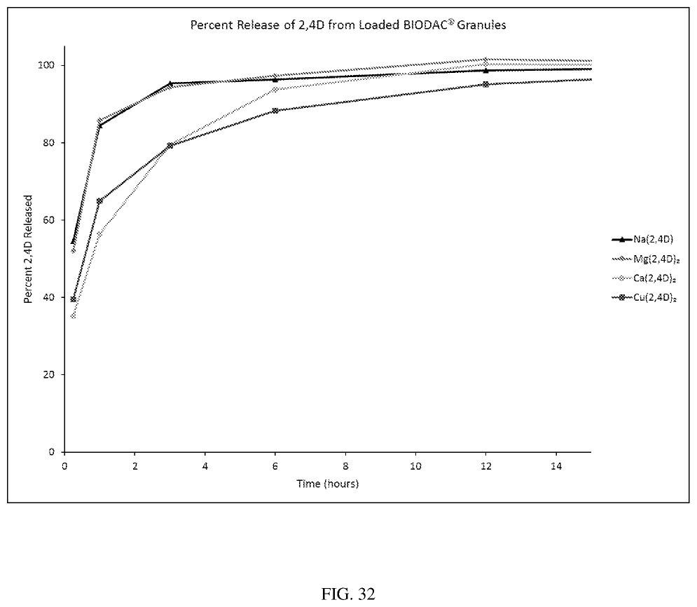

BIODAC® is a commonly used granule for carrying pesticides. Granules were loaded with 2,4D salts to determine if the chemistry could be applied to existing carriers instead of tableting. Saturated 2,4D salt solutions in dimethyl sulfoxide were prepared by adding the corresponding salts until no longer soluble. 1.0 g of BIODAC® was then soaked in these solutions for 70 hours. The resulting solids were isolated and rinsed with deionized water to remove surface particulates. These were then immersed in 1 L of deionized water stirred at 60 rpm at room temperature to determine the release rate profile. FIG. 32 displays the release rates and demonstrates that the chemistry disclosed herein can be applied to existing particulate carriers, such as BIODAC®.

### Example 24

Preparation of a terrestrial system with 2,4D salts and modeled rain events.

200 mL of sand was layered in a Buchner funnel with filter paper. 2,4D salts were blended with 5.0 g of sand, and layered atop the 200 mL sand bed and exposed to 7×200 mL flushes of deionized water. 2,4D concentration was measured in the flush water to study how the associated metal impacted how rapidly 2,4D was lost from the surface.

### Exact Formulations:

A. 0.039 g Na(2,4D) 5 g sand
B. 0.039 g Mg(2,4D)₂ 4.96 g sand
C. 0.041 g Ca(2,4D)₂ 4.94 g sand
D. 0.045 g Cu(2,4D)₂ 4.9 g sand

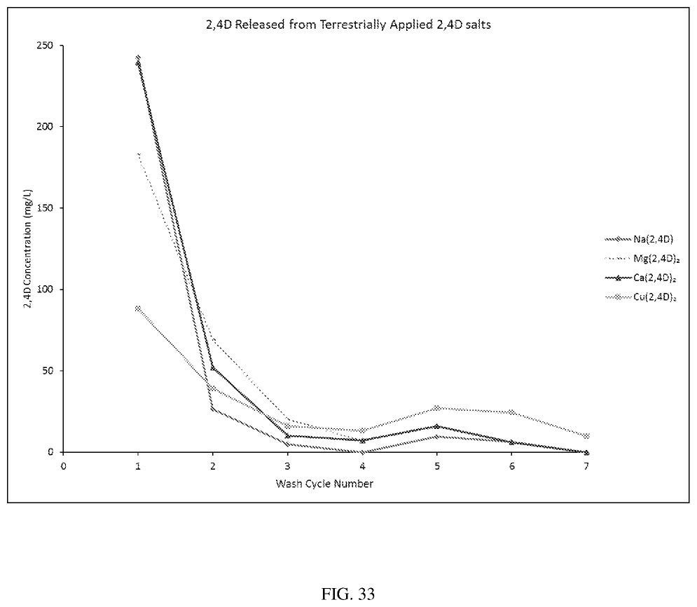

FIG. 33 shows the concentration of 2,4D in each subsequent 200 mL flush. In a terrestrial application, 2,4D lost from the surface would no longer be available to treat the target plant. These results demonstrate that the different salts exhibit different release rate profiles. Cu(2,4D)₂ would be most tolerant to frequent exposure to rain or watering events.

### Example 25

Thermal stability of 2,4D formulations with metal hydroxide tablets.

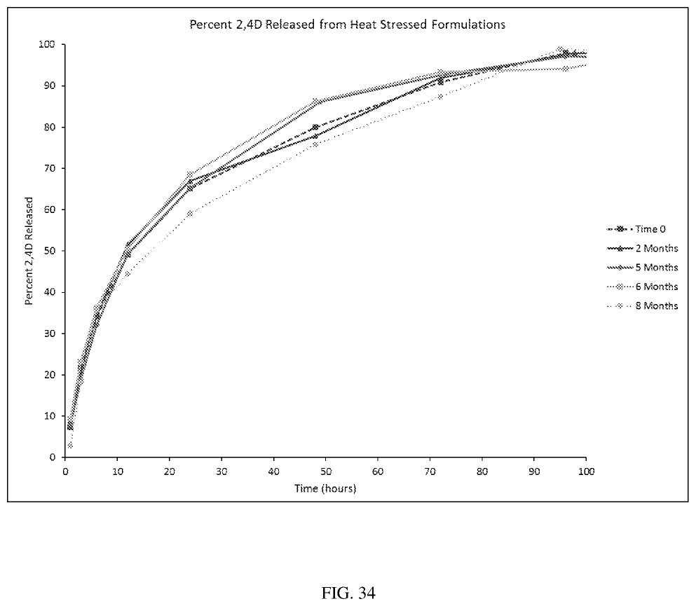

Tablets from Example 6B were stored in a dehydrator at 135° F. and removed at designated intervals to determine the impact of heat on long term stability. FIG. 34 (average of two trials) shows that release rates remain the same within experimental error, which demonstrates that the formulation is tolerant of temperatures that would be experienced during storage and shipping.

### Example 26

Thermal stability of Triclopyr formulations with metal hydroxide tablets.

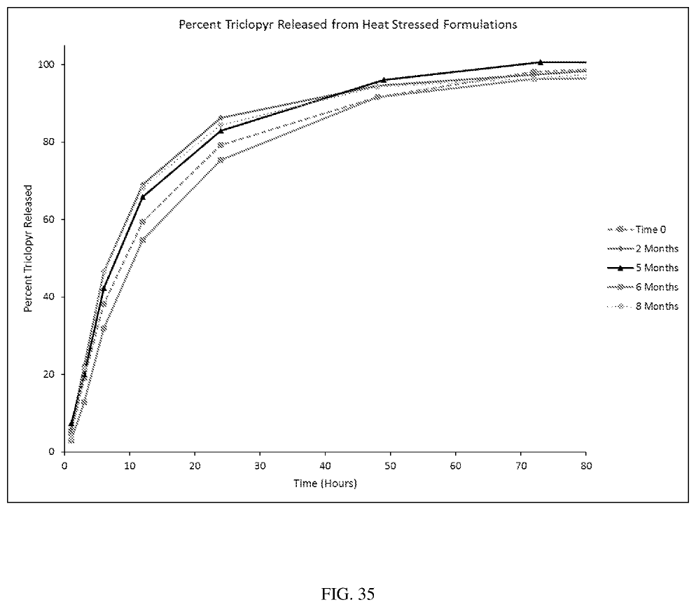

Tablets from Example 7B were stored in a dehydrator at 135° F. and removed at designated intervals to determine the impact of heat on long term stability. FIG. 35 (average of two trials) shows that release rates remain the same within experimental error, which demonstrates that the formulation is tolerant of temperatures that would be experienced during storage and shipping.

### Example 27

Synthesis of endothall salts with metals ions in different ratios.

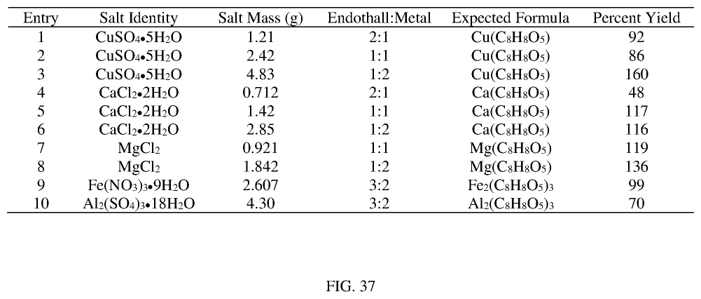

Carboxylates are known to produce network solids with different metal ions. The resulting structures of these solids depends on the conditions of the synthesis. To better probe this effect with endothall, dipotassium endothall was combined with magnesium, calcium, copper, iron or aluminum salts. The theoretical solids resulting from this process should be Mg(C₈H₈O₅), Ca(C₈H₈O₅), Cu(C₈H₈O₅), Fe₂(C₈H₈O₅)₃, or Al₂(C₈H₈O₅)₃, respectively. The appropriate salt was dissolved in 10.0 mL of deionized water, then 5.0 mL of Aquathol® K was added to the stirring salt solution. These solutions were vigorously stirred for 24 hours and were shaken occasionally to loosen any solids too thick to stir. The resulting solutions were centrifuged and solids dried to constant mass at 160° F. in a dehydrator. FIG. 37 displays the ratios and percent yields for these reactions.

The expected formulas for these metals are provided, and were derived by balancing the charge between the endothall and the metal ion. However, as is seen in the table, the percent yields do not align with that assumption. For the copper and calcium series, if formation of the network solid consisted of a one to one ratio between endothall (−2 charge) and metal (+2 charge), we would expect to see roughly half the amount of solid for the 2:1 endothall to metal ratio as we do for the 1:1 or 1:2 endothall to metal ratios. In the case of calcium, we observed this trend (FIG. 37, entry 4 vs. entries 5 and 6). Conversely, in the case of copper, this trend was not observed with 2:1, 1:1 and 1:2 leading to 92, 86 and 160 percent yield, respectively (FIG. 37, entries 1-3). Furthermore, the solid from entry 1 exhibited a different shade of blue than entries 2 and 3, indicating there are likely differences in the solid state structures of these compounds despite being prepared in the same fashion, just different stoichiometry. Lastly, yields of over one hundred percent likely indicate some level of hydration or incorporation of other counter ions into the solid state structure.

The endothall salts with magnesium exhibited a similar trend to the 1:1 and 1:2 ratios of calcium-endothall, with the 1:2 having a higher percent yield, potentially indicating a higher level of hydration (FIG. 37, entries 7 and 8). The metals with a 3+ charge (iron and aluminum) readily formed solids as well, and dried faster than the others, potentially indicating lower levels of hydration. Taken together, these results indicate that trends can be expected in the formation of these types of solids, however, they cannot be predicted prior to experimentation.

1. A pesticide composition comprising:
(i) at least one herbicide selected from the group consisting of diquat, flumioxazin, endothall, triclopyr, 2,4-dichlorophenoxyacetic acid (2,4-D), imazamox, fluridone, pyraclonil, glufosinate, florpyrauxifen, and a salt thereof; and
(ii) at least one metal containing compound, wherein the metal containing compound comprises a metal having a valency of +2 or higher, and is selected from the group consisting of calcium chloride, calcium hydroxide, magnesium choloride, magnesium hydroxide, magnesium stearate, copper hydroxide, cupric sulfate, and a mixture thereof
wherein the herbicide is coated with the metal containing compound.

2. (canceled)

3. (canceled)

4. (canceled)

5. (canceled)

6. The composition according to claim 1, wherein the composition in a form selected from solid or liquid.

7. The composition according to claim 1, wherein the composition is in a form selected from the group consisting of granules, tablets, and pellets.
